(19) United States
(12) Patent Application Publication
(10) Pub. No.: US 2021/0390485 A1
(43) Pub. Date: Dec. 16, 2021

(54) PROFESSIONAL SERVICES TRACKING, REMINDER AND DATA GATHERING METHOD AND APPARATUS

(71) Applicant: Dinvy, LLC, Milwaukee, WI (US)

(72) Inventor: Matthew Lautz, Pewaukee, WI (US)

(21) Appl. No.: 17/349,611

(22) Filed: Jun. 16, 2021

Related U.S. Application Data
(60) Provisional application No. 63/039,866, filed on Jun. 16, 2020.

(51) Int. Cl. G06Q 10/06; G06Q 10/10

(52) U.S. Cl. CPC G06Q 10/06315; G06Q 10/103; G06Q 10/06312; G06Q 10/063114

(57) ABSTRACT

A system and methods for managing professional services for an entity that employs a plurality of persons wherein each person is a resource, the system comprising a system processor, at least a first source database storing a plurality of service records, one service record for each of a plurality of professional service activities, a plurality of team messaging application programs, each resource routinely using one of the messaging application programs, a notification specification database storing a plurality of notification specifications, each defining a trigger condition set including at least one trigger condition, the processor programmed to perform the steps of (i) examining at least a subset of the service records for any one of the trigger condition sets, (iii) upon one of the trigger condition sets occurring, accessing the notification template associated with the trigger condition set that occurred, (iv) identify the team messaging application program used by at least a first receiver that is to receive a notification, (vi) generating a notification using the accessed notification template and (vii) transmitting the notification to the at least a first receiver using the identified team application program.

### CROSS-REFERENCE TO RELATED APPLICATIONS

This application claims priority to and incorporates by reference in its entirety U.S. provisional patent application Ser. No. 63/039,866 which was filed on Jun. 16, 2020 and which is titled “Project Management Method and Apparatus”.

### STATEMENT REGARDING FEDERALLY SPONSORED RESEARCH OR DEVELOPMENT

Not applicable.

### BACKGROUND OF THE DISCLOSURE

The field of the disclosure is professional services management systems and more specifically an automated system for automatically tracking professional services activities and persistently collecting user activity information that can be used to better track service progression and allocate resources among simultaneous and future services. The disclosure is also related to a system that enables a user to customize a professional services status notification sub-system to fit user preferences. Exemplary systems are provided for professional services project tracking, time entry, invoicing, task progression, service quotations, and others.

Modern companies facilitate hundreds or even thousands of different types of simultaneous projects as part of their normal business operations. Most projects are broken down into a set of simultaneous or serial tasks that need to be performed to compete the project. For instance, an exemplary project may include a total of 10 tasks to perform including first, second and third serial tasks, fourth and fifth tasks that can be performed in parallel, sixth through eighth tasks that can be performed in parallel, and ninth and tenth serial tasks. In many cases, many of these projects are performed internally by company employees and in other cases projects or at least a subset of project tasks are farmed out to “outside service providers” (e.g., service providers that do not work directly for the company) that specialize in services geared toward efficiently completing specific project or task types.

Prior to starting a new project, most companies set a project target completion date and require a budget. The project completion date is important to make sure that the project results fit within larger company time schedules. Project budgets are needed to ensure that costs are in line with expectations and financial considerations. When it comes to hiring outside service providers, budgets and schedules (e.g., fast and accurate) are very important and often are determinative factors in which provider is selected to handle projects.

In many cases specific projects are assigned to specific project managers (e.g., a company employee or an employee working for an outside service provider) and each manager relies on prior project experience to break down specific projects into specific tasks and to identity resources (e.g., employee time) needed to complete specific tasks. The managers then use resource schedules to identify available resources required complete tasks and develop detailed budgets based on required resources, available resources, and task specific billing rates for available resources. Thus, for instance, if a third project task requires 20 hours of a first available employee's time to complete (based on prior similar tasks in prior projects and the first employee's capabilities in handling those prior similar tasks), the first employee's task specific rate is $200/hour, and the first employee has 20 hours available after a second task completion target date and prior to a target end date for the third task, the third task fee may be set at $4,000 with the subsequent date as a third task completion target date. Fourth through sixth simultaneous task start dates may be scheduled for any time after the third task completion target date when resources for completing those tasks are available.

In theory, over time, as resource capabilities increase and more accurate data related to needs and capabilities is developed, schedule and budget estimates should become more accurate. As estimates become more accurate, teams (e.g., in company or outside service provider teams) should become more comfortable with estimate accuracies, should be able to compress project times and reduce overall budgets increasing odds of attracting more work and increasing service for clients, and should be able to increase profits based on realistic timelines and related budgets.

Project management software has been developed for tracking historical project resource requirements and budgets, for planning future projects, for tracking ongoing project tasks, budgets and completion dates, and for adjusting project schedules or redirecting resources when necessary to keep projects on schedule. Task progression and resource use is very subjective and difficult to track. To this end, hours spent on a task do not always translate into a specific percent of task completion. For instance, where a task is slated to take 20 hours to complete, after an employee spends 15 hours on the task, while the task may be 75% complete in some cases, in other cases it may only be 20% complete and, in still other cases, it may be 100% complete, depending upon how efficiently the employee(s) worked, any unforeseen complications, and/or speedy completion of subtasks, etc.

In most cases because of the subjective nature of task progression, the employee or employees performing a task are in the best positions to assess the number of hours spent on a task, task progression toward completion, etc. For this reason, most project management programs provide a user interface for entering information specifying time to be billed to a client for a specific task as well as other information indicating task status and/or modifications to resources anticipated to be required to complete the task. For instance, an employee that worked on a task for 8 hours in a day may only indicate that 5 hours should is billable while 3 hours is not billable and may also indicate that while 12 more hours are budgeted for completing the task, an addition 5 hours (for a total of 17 hours) will be required and should be scheduled accordingly. In addition to changing the employee's schedule and realization information related to the task, the time requirement increase may also change employee schedules related to employees that need to perform other subsequent project tasks or that should be assigned to other projects, is useful for assessing actual time required for the employee to complete the specific task (e.g., was the initial estimate too high or too low), and for other purposes.

To access a project management time entry user interface, an employee periodically opens up the interface and logs onto the management system via username and password entry. Once the interface is accessed, the user typically navigates to several different project specific interface screens and fills in fields indicating time spent on project tasks as well as comments about the task status or other information. In at least some cases project management software is programmed to track project task schedules and to send automated e-mails to employees when task time entries are expected but have not been received. For instance, a system expecting an employee to have billed 8 hours to a task by 5 PM on a Wednesday may generate and send an automated e-mail reminder at 8 PM to the employee reminding the employee to access and log onto the user interface to enter her time.

Unfortunately, while employee driven status tracking software solutions work well in theory, in reality these solutions are only as good as the data entered by employees which is often lacking for several reasons. First, employees often feel overburdened with work related tasks where turnaround times are often fast and the thought of having to access and negotiate a time and project tracking software program once or even several times a day as the employee switches from one task or project to another is enough for the employee to forego disciplined and timely reporting. Exacerbating matters, many employees work on multiple projects each day and some time entries have only short durations (e.g., a fraction of an hour). Instead or reporting a task related time when switching tasks, employees often seek to limit the number of times they access the tracking software to once a day or less. Even in cases where project tracking systems generate periodic time entry reminders for perceived missing time, employees routinely learn to ignore these reminders until they reach an urgent status.

When employees do access time entry software, access is often at the end of a day or longer period when the employee is often drained of energy and feels rushed. For this reason, in many cases time entries and related information entered is kept to a minimum and therefore the entered information is often incomplete or insufficient for driving many of the applications that rely on that input to generate outputs based on data that reflects current reality. In addition, because many employees feel rushed when entering information, time and other information entry errors are appreciable. Because employees often only enter data once or less per day or week, small time charges are often forgotten and some task charged time durations are inadvertently increased as small uncharged time periods are folded into larger time charges assigned to a client or are even inadvertently assigned to other clients (e.g., a ten minute period that should be assigned to a first task associated with a first target that occurs between two longer periods for a second client may inadvertently be charged to the second client as part of a single charged time duration). In many cases when time is recorded hours or days after time is spent on a task, employees tend to underestimate time spent and therefore unbilled time increases substantially.

Where future project planning is based on inaccurate task completion durations, future projects are mis-scheduled and budgets are wrong. In these cases companies are faced with absorbing unexpected budget overruns and having to explain project delays to clients which adversely affects relationships and prospects related to providing future services to unhappy clients.

In many cases project managers have access to project management interface tools enabling review and analysis of project progress and useable to redirect resources in an attempt to keep projects on schedule and on budget. While these management interfaces are useful, unfortunately they too are cumbersome to use and often require a manager to access different databases to develop a detailed understanding of what is happening with respect to different projects. In most cases, a manager may be unaware of issues with project progress for several days even when management information in databases or information that is missing from databases could be used to identify and address issues much earlier.

Even in cases where project management software generates e-mail notifications to report project irregularities to a manager, those notifications are typically pre-canned and only include a small number of warning types for very specific purposes (e.g., indicating late time entries) and require a manager to access other software applications to drill down into characteristics of any irregularities. In these cases there is no way for a project manager to customize project notifications to report specific project circumstances that the manager may deem interesting.

Thus, what is needed is a better system for collecting task time entries and other task related information from employees that perform various tasks as part of large project management systems. In at least some cases, because the system should obtain better, more accurate data, the system should be useable to help project managers better plan and budget project task schedules which should be appealing to clients. It would also be advantageous to have a system where project status notifications are customizable for specific employers, project managers, and other persons that interact with the system and to customize for specific projects when advantageous.

### SUMMARY OF THE DISCLOSURE

It has been recognized that many employees that perform team based project tasks as part of larger project activities routinely use project collaboration and communication software application programs to facilitate project collaboration and communications. For instance, exemplary project collaboration and communication application programs include Slack message sender, MSTeams message sender, Zoom Message Sender, and others. These communication application programs enable team members to routinely and simply communicate via channels where each channel is associated with a specific project, topic, or team. Here, all communications associated with a channel are stored in and associated with that channel so that all channel relevant communications can be accessed in one place.

Channel based communication and content association is more intuitive than E-mail and other prior types of the communications where locating information related to a specific project, team or topic can be difficult. In many cases task performing employees keep a preferred collaboration and communication software application program open and operating essentially all the time while working so that they can receive and respond to queries and postings by other team members and so that they can post their own queries and other information to appropriate channels when desirable. Thus, many team project based employees always have access to their collaboration and communication applications while working and are very familiar with using those applications to quickly review and respond to queries and other postings by other employees on their teams or associated with projects. An employee's project collaboration and communication software application will be referred to hereinafter as the employee's “persistent team application”, “team application” or “message sender application” or program unless indicated otherwise.

Different employees at large companies may use different message sender applications and it is contemplated that the disclosed systems will be able to identify which message sender application a specific employee uses and communicate with that employee using her preferred message sender application. Thus, for instance, a first employee may use Slack message sender while a second uses MSTeams message sender and, in this case, a system processor may be programmed to identify which application is used by which employee and send messages/notifications in each employee's team application when required. In some cases a first employee may routinely use different team applications (e.g., both Slack and MSTeams) and the system processor may be programmed to assess which of two or more team applications is currently active for the first employee when a notification is to be sent to the first employee and may automatically communicate with the first employee using the active team application.

In at least some cases a system runs a software bot notification engine/application that uses scheduled project tasks to identify anticipated times when employees are expected to enter task specific progression data such as hours worked, tasks completed, adjustments to anticipated time required to complete tasks, etc. To identify anticipated times, the bot engine uses project schedules to identify when employees are scheduled to spend time on the each project. In cases where an employee spends scheduled time on a project task and enters her time, in at least some embodiments the system does not generate any notification to the employee regardless of the time entered assuming that the entered time is accurate. In cases where no time is entered when expected, the bot generates a notification/query in a format that drives the employee's persistent team application to be sent to the employee. In some cases, even when an employee enters time, the bot engine may be programmed to generate and send a notification to the employee confirming accuracy of the entry, questioning completeness of the entry or querying the employee if the entry is inconsistent with a value that was expected. Here, “when expected” may be within a few minutes of a time at which the employee should have completed her hours on a task, within an hour of that time, or within some other duration of that time, so that the employee has some leeway in which to report hours worked.

In addition to generating and sending notifications to employees through their persistent team applications, the system may be programmed to generate and send notifications to others such as, for instance, project managers, system administrators, other project team members, or even specific individuals that have nothing to do with specific projects, using their specific persistent team applications (e.g., Slack message sender). Hereinafter, unless indicated otherwise, the term “recipient” will be used to refer to an individual that receives a notification from a bot engine.

In particularly advantageous cases bot notifications include pre-canned selectable answers for a recipient to select from to provide missing information to the project management or other data collecting and managing software. For instance, a question may be “Did you work 4 hours on the MNL project today?” and selectable answers may include “Yes” and “No”. As another instance, a different question may be “How many hours did you work on the MNL project today?” and answers may include “30 minutes”, “1 hour”, “2 hours”, “4 hours”, etc. In other cases a bot notification may provide a text field for entering a short answer to a query.

At a high level the idea here is to make it extremely simple and non-burdensome for recipients to enter task/project progression information into a project management system. By automatically providing queries within a recipient's familiar and persistent team application when some irregularity or specific set of circumstances exists where response is as simple as selecting one or more options presented by the system, compliance with time entry expectations and other data entry requirements is increased appreciably. Not only does this allow a company to bill fees for services earlier, it enables better project management resource allocations as resources can be allocated on the fly where needed when project task completion is delayed or expedited for any reason.

In some cases bot notifications/queries may be presented sequentially where second, third, and subsequent “follow on” notifications are generated by the bot engine in response to answers from prior notifications. Thus, if an employee responds that he worked 8 hours today, a second query may be “Select the client you worked for.” and a list of clients for projects the employee is assigned to may be provided for client selection. A third query may present a list of projects for the client that the employee is working on and ask the employee to select the project to which time should be billed, and so on. In some cases where second and subsequent notifications are triggered by recipient answers to prior notifications, the bot engine may branch to different follow on notifications bases on the recipient's answers to prior notifications. Thus, for instance, where an employee responds that she has been working on a project for ABC Corp., the bot engine may be programmed to identify all projects for ABC Corp. that the employee is scheduled to work on and may present a project options list to the employee for selecting which project the employee's time should be billed to, effectively branching out in a different direction. Hereafter, unless indicated otherwise, follow on messages will be referred to as “branch notifications” or “follow on notifications”.

In cases where less or more time than expected is entered into the system at a time, the bot engine may automatically generate and send a notification to the employee querying about accuracy of the entry, if the difference in time is expected to affect the task or project schedule, if more resources are needed to keep the task and project on schedule, etc. Anticipated schedule changes can be automatically presented to a project manager for consideration in at least some embodiments. In other embodiments the system may automatically assess the need for more resources to keep the task on schedule and may use other employee schedules to identify a possible schedule maintaining solution to suggest to a project manager.

In cases where a recipient does not respond to a notification within some threshold time period, the system may automatically generate a second notification which is sent to the recipient via the recipient's persistent team application. Where a recipient is noncompliant after several notifications, the bot engine may be programmed to send a notification to a project manager or other system administrator to prompt the manager to encourage the recipient to comply.

In at least some cases, good/accurate employee capability data will be developed over time as employees perform different tasks or portions of tasks. For instance, for a task type that is repeated in different projects, the system will develop employee specific estimates of time required to complete those tasks. For example, over time, the system may recognize that first and second employees take 10 and 15 hours to complete a specific task that is essentially replicated in many projects. The task data may be useable by managers to better schedule and budget future projects. For instance, where a project manager uses project planning software to select the second employee to complete a task in 10 hours when that employee routinely requires 15 hours, the system may automatically suggest that the 10 hours allotted will be insufficient, that 15 hours is more realistic, and perhaps suggesting the first employee that averages 10 hours to complete the task assuming that the first employee has 10 unscheduled hours prior to an end date/time for the task. Here, the suggestion may be within the planning software itself or, in other cases, where a bot engine has access to a database(s) that stores project plan information (e.g., resource requirements and schedules) and a database that stores employee capabilities (e.g., resources (e.g., employees), tasks, and average times to complete tasks), the bot engine may automatically generate and send notifications in the planner's persistent team application presenting the suggestion.

In at least some cases, good/accurate data related to an employee's ability to assess time required to complete project tasks and task completion dates will be developed for each employee. For instance, a first employee may routinely overestimate his capability to complete tasks in short periods of time or select completion dates that are simply unrealistic (e.g., believe a task can be completed in 10 hours and in one week when data shows 20 hours over 3 weeks are required for similar tasks). As another instance, a second employee may routinely underestimate her capability to complete tasks in a small number of hours or may estimate completion dates much later than reality. In these cases, the bot engine may automatically provide notifications to a manager to help the manager assess how realistic task completion or project completion is by specific dates as well as budget estimates.

In some cases bot engine notifications may be triggered whenever time entry is expected but not entered. For instance, time entry reminders or queries may be automatically generated and sent to an employee every day when time is not been entered to ensure that the employee releases time as fast as possible so schedules can be updated and resources reallocated when needed. Here, in at least some cases, the bot engine will assume that an employee is continuing work on a most recent task when time entry messages are every few hours and will frame up the message and response options accordingly to limit the amount of effort required to respond to the query. Thus, for instance, where an employee's most recent time entry was related to a second task of a first project, a next time entry message may be “Have you spent the last two hours working on the second task of the first project?” with selectable “Yes” and “No” options. In this case, if the user answers “No”, the bot may generate other notifications to capture what the employee was working on in the preceding 2 hours.

As another instance, if a first employee only responds to bot time entry messages after 4:30 PM, the bot engine may be programmed to only send time entry messages at 5 PM if time has not been entered by the first employee. Other exemplary message triggers may be related to sensing work file or project change based on content accessed via an employee's computer. Thus, for instance, where an employee works in a first document that is associated with a first client, first project, and first task for 2 hours and then switches to a second document that is associated with a second client, second project and second task for 2 hours, the bot may automatically determine that it is likely the employee was working on the first task for the first 2 hours and the second task for the second 2 hours. Here, upon switching to the second document, the bot may recognize the switch and may generate a time entry message to prompt the employee to confirm that the first two hours were spent working on the first task. At the end of the second 2 hour period when the employee exits the second document, the bot engine may generate a second time entry message prompting the employee to confirm that the second two hours were spent working on the second task. In an alternative, after all four hours the bot engine may be programmed to generate a single message prompting the employee to confirm that the first two hours were spent on the first task and the second two hours were spent on the second task.

In at least some cases it is contemplated that at some point during scheduled employee work on a task, the bot engine will automatically generate and transmit an estimated additional time required to complete a task notification to an employee. For instance, assume a case where an employee is scheduled to spend 10 hours on a task and has already recorded 8 hours to the task. Here, a message trigger may be “2 scheduled hours remaining for the task” for an employee at which time the additional time notification is generated and sent. Again, here, in at least some cases the notification would include tools that make it simple to respond within the notification so that the employee does not have to access the project management software in order to enter the estimated time to completion.

In at least some cases it is contemplated that at some point during scheduled employee work on a task, a bot engine will automatically generate and transmit an estimated completion date (and in some cases time) for a project task notification to an employee. For instance, assume a case where an employee is scheduled to complete a task by July 22 and it is now July 20. There may be a 2 day trigger so that when time is within 2 days of a target completion date, a bot engine notification queries the employee for a current completion date estimation. Again, here, in at least some cases the notification would include tools that make it simple to respond within the notification so that the employee does not have to access the project management software in order to enter the estimated completion date.

Other message and notification triggers may be flow related. For instance, where a bot engine can monitor other employee workstation or laptop software use, the bot engine may be programmed to recognize when an employee is in a flow state based on documents or other records accessed or interacted with or content generated. In these cases, the bot engine may be programmed to generate time entry and other message types only when the bot perceives that an employee is not within a current flow state.

Importantly, in at least some cases the bot engine notifications are not just simple reminders to access the project management software and instead are messages that include in message tools that pre-can most likely responses so that a recipient can enter time and projected schedule data and other responsive information within the recipient's persistent team application in an intuitive and speedy manner. In other embodiments at least some of the notifications may be more like simple reports that report a particular state or project or task status to a manager or other employee or recipient. For instance, for all projects at ABC corporation, all project managers may receive a notification whenever the budget remaining for any project that the manager manages is 10% or less than the project's total budget (e.g., on a $100,000 budget, 90% has been spent and only $10,000 is left). As another instance, any time an employee is scheduled to bill any time on a first project task during a period (e.g., a day) and no time is spent on the task, the project manager for the project including the task may be sent a notification that the employee spent no time on the task. Many other report type messages are contemplated.

When an employee indicates that an estimated task completion date and/or time has changed, a bot engine may automatically generate other messages for one or more project managers or other employees affected by the date/time change so that those employees can adjust their expectations accordingly. For instance, if a first employee performing a first task indicates that the first task will be completed a week earlier than scheduled, the bot engine may generate and send a message to the second employee so the second employee has the option to initiate the second task earlier than expected. The bot engine may be programmed to assess how the earlier completion date could change an entire project schedule and may present a project schedule change option to a project manager. For instance, assume again that the first task will be completed one week earlier than originally scheduled. If there are resources available to complete second through tenth project tasks on a schedule that is expedited by one week, the project schedule change may trigger the bot engine to suggest the expedited schedule to a manager and the manager may have the option to change the schedule accordingly. In the above case if resources are available to expedite the second through fifth out of ten tasks, the bot may suggest that partial rescheduling to the manager.

In at least some cases particularly important queries include: (i) Did you spend time working? (ii) What project and task were you working on during the time? (iii) Are hours in addition to the scheduled hours needed to complete an item? (iv) Will the item be completed in less time than the scheduled time? (v) Is the completion date/time too long, too short or just right? Other queries may seek to gather information related to an employee's perception of her efficiency. For instance, if an employee bills 6 hours to a task, the query may have the employee rank her perceived efficiency from 1 to 10. In other cases, the query may seek information related to hours worked on a task and hours billed and use that information as a proxy for user efficiency. The efficiency data may be used to adjust fees or billing rates in some cases. In other cases the efficiency data may be used to set realistic expectations on how many hours specific employees can be expected to bill to client matters in a day and to set realistic time and project schedules.

While at least some disclosed systems will be completely configured so that all triggers, notifications, branch queries, recipients and bot engine databases are completely specified, other systems are contemplated where at least some and, in some cases, all automatic notification and query information can be customized by a system programmer (e.g., an overall system manager, a project manager or other individual) so system notifications meet user preferences. To this end, it has been recognized that project managers have different capabilities, expectations, and styles so that, while some managers may find lots of project status notifications helpful and may want to maintain stringent rules related to time entry, schedule compliance, and other project information, other managers may find large numbers of status notifications to be burdensome and distracting and only want minimal queries to employees regarding time and other project data entry. Unless indicated otherwise, hereafter a programmer, manager or other system user that enters information to specify one or more project notification specifications will be referred to as a “programmer”. In some cases, programmer status may be provided for only a small set of entity employees while in other cases many employees may be able to program notification specifications for themselves and/or others. In some cases a programmer will be able to program notification specifications for herself as well as for a subset of other system users (e.g., team members, employees managed by the programmer, etc.).

To enable bot engine customization, at least some embodiments of the disclosed system provide a simple notification specifying user interface that enables a programmer to define customized notifications. In its simplest form, the user interface enables the administrator to specify notification characteristics including notification recipients, notification trigger conditions (e.g., project or service record circumstances or criteria that cause a bot engine to generate and transmit a notification to recipients), a data source to which the triggers should be applied, and a notification template useable to generate text that constitutes a notification message. Once a customized notification is specified and activated, a bot engine applies the trigger conditions to the specified data source and, when the trigger conditions occurs, the bot engine generates and transmits notifications based on the associated notification template to all recipients associated with a specific notification type.

In at least some cases the notification specifying user interface includes a JavaScript Object Notation (JSON) or other simple programming text editor where a programmer uses a JSON or other simple text syntax to specify at least a minimum set of notification characteristics. When using a JSON text editor, the administrator enters key and value pairs separated by a colon (e.g., key:value) consistent with the JSON syntax to specify notification characteristics. Exemplary JSON keys supported by the system include “source” (e.g., the database to which trigger criteria is to be applied), “receiver_ids” (e.g., identifications of individuals to receive instances of the notification when trigger criteria are met), “conditions” (e.g., specifying trigger criteria), “audience” (e.g., a class of individual to receive notifications when trigger criteria are net, for instance, project managers is a class of individuals), and others specified or not hereafter. One other important key supported by an exemplary JSON based system is an “intent” which is used to specify a notification template to be used to generate notifications when trigger criteria are met. A set of specified characteristics that at least minimally define data needed to instantiate a notification will be referred to hereinafter as a “notification specification” unless indicated otherwise.

Intent or notification templates are defined and stored in an “intent” database and, in a JSON based system, each instance of a notification in the intent database includes a value that can be used in an “intent”:“value” pair to specify a specific intent and an associated notification template (e.g., the value calls out a specific template to use to generate a notification. Each template includes text and variable fields that are populated from data in one or more system databases when a notification is to be generated and transmitted.

In at least some embodiments trigger criteria specified by a “conditions” key:value expression may include simple criteria such as, for instance, that remaining budget for a project is at most $1000 and, in other cases may be much more complex, requiring several different criteria or derivatives of values stored in one or more databases.

Still other embodiments include a simplified user interface wherein the interface presents simple queries to a programmer to solicit information required to create JSON based notification specifications. For instance, the interface may provide a list of exemplary notification types supported by the system where the programmer can then select one notification type at a time to instantiate an instance of that type in a notification specification. The interface may then query the programmer for intended notification receivers and, where required, conditions that will trigger the notification. Other sequences of queries to instantiate notification instances are contemplated.

Some embodiments include a system for managing professional services for an entity that employs a plurality of persons wherein each person is a resource, the system comprising a plurality of target source databases, each source database storing a plurality of service records one service record for each of a plurality of professional service activities, a plurality of team messaging application programs, each messaging application program used by at least a subset of the resources to electronically communicate, a processor programmed to perform the steps of: during a notification specification programming process: (i) receiving a target source indication from a programmer wherein the target source identifies one of the plurality of target source databases; (ii) receiving a trigger condition set from a programmer wherein the set of trigger conditions specify at least a first database condition that warrants a notification; and (iii) receiving audience identifying information indicating at least a first receiver to receive notifications upon the trigger condition set occurring, during normal operation after programming: (i) examining each service record for occurrence of the trigger condition set; (ii) for each service record where trigger condition set occurs: (a) using a notification template to instantiate a notification instance; (b) identifying the messaging application program used by the at least a first receiver and (c) transmitting the notification instance to the at least a first receiver via the identified messaging application program.

In some cases the steps of receiving a target source indication and a trigger condition set include presenting a simple text editor via a display screen and receiving text expressions from a programmer that are entered into the text editor via a user input device. In some cases the simple text editor is a JSON text editor. In some cases the step of receiving audience identifying information includes receiving default audience specifying information. In some embodiments the default audience specifying information includes receiving information that specifies a manager of professional service activities associated with a professional service record.

Some embodiment further include a notification template database that stores a plurality of notification templates and wherein the processor is further programmed to perform the steps of receiving a notification template selection from a programmer that identifies at least one of the plurality of notification templates to use to generate instances of notifications when trigger conditions occur. In some cases at least a subset of the trigger conditions in the trigger condition set each includes an operation, a value and at least one field. In some embodiments the notification instance includes a query and a plurality of receiver selectable answers and wherein, when an answer is selected by the first receiver, the processor is further programmed to receive the answer in a return message via the identified messaging application program. Some embodiments further include a notification specification database that stores a plurality of notification specifications including at least a second notification specification that includes a second trigger condition set, wherein information in the return message operates as a trigger condition in the second trigger condition set so that the system processor responds to the return message by generating and transmitting a second notification to the receiver.

In some cases the audience is dynamic (e.g., changes as a function of the service record that meets a trigger condition set) and in other cases the audience is static and includes specific persons irrespective of which service record met trigger conditions or criteria. In some cases the notification template includes text and variable fields and wherein the processor fills in the variable fields automatically using information from other system databases. In some cases the plurality of target source databases include at least one project management database. In some cases the plurality of target source databases includes at least one invoicing database.

In some embodiments the step if receiving a target source includes receiving at least first and second target sources, the step of receiving a trigger condition set includes receiving first and second trigger condition sets associate with the first and second target sources, respectively, and the step of examining each service record for occurrence of the trigger condition set including examining each service record in the first target source for the first condition set and each service record in the second target source for the second trigger condition set. In some cases the receiving steps include providing a graphical user interface via a display screen that presents a series of screen shots that request information related to target source, trigger condition set and audience, the processor further programmed to convert programmer source, trigger condition set and audience definitions into simple text expressions that together define a text based notification specification.

In some embodiments each service record includes information related to resources allocated to the associated professional service activity. In some embodiments the messaging programs include Slack message sender and MSTeam Message Sender.

Some embodiments include a system for managing professional services for an entity that employs a plurality of persons wherein each person is a resource and each resource regularly uses one of several different team messaging application programs to communicate with other resources, the system comprising a system processor, at least a first source database storing a plurality of service records, one service record for each of a plurality of professional service activities, a plurality of team messaging application programs, each messaging application program used by at least a subset of the resources to electronically communicate, a notification specification database storing a plurality of notification specifications, each notification specification defining a trigger condition set including at least one trigger condition, a notification template, and audience specifying information, at least a subset of the notification templates including a query and receiver selectable options which, when selected, generate a response that is transmitted to the system processor, the system processor programmed to perform the steps of (i) receiving and storing responses from resources to prior transmitted notifications in a response database, (ii) examining at least a subset of the service records and the response database for any one of the trigger condition sets, (iii) upon one of the trigger condition sets occurring, accessing the notification template associated with the trigger condition set that occurred, (iv) using the audience specifying information associated with the trigger condition set to identify at least a first receiver, (v) identify the team messaging application program used by the at least a first receiver, (vi) generating a notification using the accessed notification template and (vii) transmitting the notification to the at least a first receiver using the identified team application program.

In still other cases the disclosure includes a system for managing professional services for an entity that employs a plurality of persons wherein each person is a resource, the system comprising a system processor, at least a first source database storing a plurality of service records, one service record for each of a plurality of professional service activities, a plurality of team messaging application programs, each resource routinely using one of the messaging application programs to electronically communicate, a notification specification database storing a plurality of notification specifications, each notification specification defining a trigger condition set including at least one trigger condition, the system processor programmed to perform the steps of (i) examining at least a subset of the service records for any one of the trigger condition sets, (iii) upon one of the trigger condition sets occurring, accessing the notification template associated with the trigger condition set that occurred, (iv) identify the team messaging application program used by at least a first receiver that is to receive a notification, (vi) generating a notification using the accessed notification template and (vii) transmitting the notification to the at least a first receiver using the identified team application program.

### BRIEF DESCRIPTION OF THE SEVERAL VIEWS OF THE DRAWINGS

FIG. 1 is a schematic view of a project management system that is consistent with at least some aspects of the present disclosure:

FIG. 2 is a simplified exemplary database that includes more detail than the similarly numbered database from FIG. 1;

FIG. 3 is a flow chart of a bot query generating and data consumption process that is consistent with at least some aspects of the present disclosure;

FIG. 4 is a screen shot of an exemplary query that may be presented to a system user/employee when a missing data trigger event occurs;

FIG. 5 is a follow on query that may be generated in response to an answer to the FIG. 4 query;

FIG. 6 is a follow on query that may be generated in response to an answer to the FIG. 5 query;

FIG. 7 presents another follow on query that may be generated in response to an answer to the FIG. 6 query;

FIG. 8 is a schematic diagram illustrating an exemplary projects source database in a simplified table form;

FIG. 9 is similar to FIG. 8, albeit illustrating a time entries database in a simplified table form;

FIG. 10 is similar to FIG. 8, albeit illustrating an exemplary and simplified project tasks database in table form;

FIG. 11 is a user database that stores user information;

FIG. 12 is a table that shows simple and exemplary JSON type key schema that are supported by at least some embodiments of the present disclosure;

FIG. 13 shows data filtering schema supported by at least some embodiments of the present disclosure;

FIG. 14 is a schematic representation of a first part of an exemplary notifications database that is consistent with at least some aspects of the present disclosure;

FIG. 15 is the second part of the notifications database shown in FIG. 14;

FIG. 16 is a flow chart illustrating an exemplary process for generating notifications and follow on notifications as trigger condition sets in system databases occur;

FIG. 17 is a screen shot on a GUI for collecting notification specifying information that is consistent with at least some aspects of the present disclosure;

FIG. 18 is similar to FIG. 17, albeit showing a next in series screen shot for collecting specification defining information;

FIG. 19 shows a screen shot of a JSON type simple text editor that is consistent with at least some aspects of the present disclosure;

FIG. 20 is similar to FIG. 18, albeit showing a next in series screen shot for collecting specification defining information;

FIG. 21 is similar to FIG. 20, albeit showing a next in series screen shot for collecting specification defining information;

FIG. 22 is similar to FIG. 21, albeit showing a next in series screen shot for collecting specification defining information; and

FIG. 23 is similar to FIG. 22, albeit showing a next in series screen shot for collecting specification defining information.

### DETAILED DESCRIPTION OF THE DISCLOSURE

The various aspects of the subject disclosure are now described with reference to the drawings, wherein like reference numerals correspond to similar elements throughout the several views. It should be understood, however, that the drawings and detailed description hereafter relating thereto are not intended to limit the claimed subject matter to the particular form disclosed. Rather, the intention is to cover all modifications, equivalents, and alternatives falling within the spirit and scope of the claimed subject matter.

In the following detailed description, reference is made to the accompanying drawings which form a part hereof, and in which is shown by way of illustration, specific embodiments in which the disclosure may be practiced. These embodiments are described in sufficient detail to enable those of ordinary skill in the art to practice the disclosure. It should be understood, however, that the detailed description and the specific examples, while indicating examples of embodiments of the disclosure, are given by way of illustration only and not by way of limitation. From this disclosure, various substitutions, modifications, additions rearrangements, or combinations thereof within the scope of the disclosure may be made and will become apparent to those of ordinary skill in the art.

In accordance with common practice, the various features illustrated in the drawings may not be drawn to scale. The illustrations presented herein are not meant to be actual views of any particular method, device, or system, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or method. In addition, like reference numerals may be used to denote like features throughout the specification and figures.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the disclosure may be implemented on any number of data signals including a single data signal.

The various illustrative logical blocks, modules, circuits, and algorithm acts described in connection with embodiments disclosed herein may be implemented as electronic hardware, computer software, or combinations of both. To clearly illustrate this interchangeability of hardware and software, various illustrative components, blocks, modules, circuits, and acts are described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the embodiments of the disclosure described herein.

In addition, it is noted that the embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a function, a procedure, a subroutine, a subprogram, etc. Furthermore, the methods disclosed herein may be implemented in hardware, software, or both. If implemented in software, the functions may be stored or transmitted as one or more instructions or code on a computer-readable medium. Computer-readable media includes both computer storage media and communication media including any medium that facilitates transfer of a computer program from one place to another.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed or that the first element must precede the second element in some manner. Also, unless stated otherwise a set of elements may comprise one or more elements.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a computer and the computer can be a component. One or more components may reside within a process and/or thread of execution and a component may be localized on one computer and/or distributed between two or more computers or processors.

The word “exemplary” is used herein to mean serving as an example, instance, or illustration. Any aspect or design described herein as “exemplary” is not necessarily to be construed as preferred or advantageous over other aspects or designs.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Hereafter, many of the system processes are described as being performed by the bot engine. It should be understood that in other cases other software applications or programs may perform some of the processes hereafter.

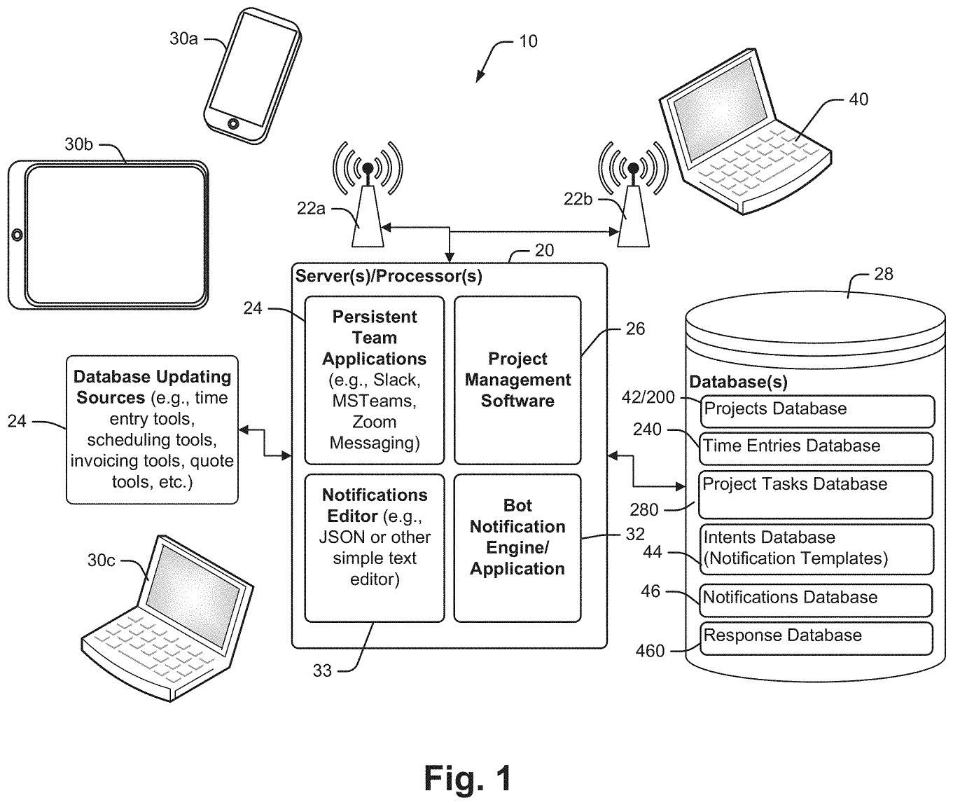

Referring now to the drawings wherein like reference numerals correspond to similar elements throughout the several views and, more specifically, referring to FIG. 1, the present disclosure will be described in the context of an exemplary computer system 10 including a server 20, a plurality of wireless access points 22a and 22b (only two shown), a database 28 and a plurality of end user computing devices 30a, 30b and 30c as well as device 40. While shown as a single server, it should be clear that server 20 may include two or more separate computing devices/servers/processors that cooperate to perform the functions, processes and methods described herein. Similarly, database 28 may include one, two or more databases that store different subsets of computer software, source data sets and system operational data.

Server 20 is linked to database 28 to run application programs stored therein and to access information and store information therein. While shown linked, it should be appreciated that database 28 may be remote from server 20 and accessed via a communication network of some type (e.g., the Internet, a wide area network, etc.). Server 20 is linked to access points 22a and 22b for wireless communication with the end user computing devices. Other user interface devices may be hard wired to server 20.

End user devices 30a, 30b, 30c and 40 may be any type of user interface devices including laptop computers 30c, 40, tablet type computing devices 30b, smart phones 30c or other types of portable or stationary computing devices that include display screens for presenting information and some type of input device (e.g., keyboard, microphone, touch sensitive display screen, etc.).

Server 20 runs several different software applications or programs including one or more persistent team applications 24, professional services management software 26 and a bot notification engine/application 32. In addition, in at least some embodiments, server 20 also runs a notifications editor 33 that enables a programmer or other system programmer to specify customized notification specifications to meet customized or preferred needs. Team applications 24 include, for instance, Slack message sender, MSTeams message sender, Zoom Message Sender, Facebook Workplace, and/or others. Each team application is used by a set of employees to communicate via channels or other computing paradigms and, in most cases, each employee uses one of the team applications essentially all the time (e.g., the application remains active during working hours and often during non-working hours as well) while working so that any messages received via the team application is received essentially immediately upon sending.

Professional services management software 26 includes one or more programs developed to help employees perform various types of activities required to provide services to customers/clients. For instance, the professional services management software may enable one or more employees to specify project management information defining different employee roles, specific employee characteristics, project task defining information, client defining information, billing information for specific clients and/or projects, and project defining details. Among other things, the project defining detail may include a schedule of items to be completed to complete a project, hours required to complete each task and task completion dates, specific employees to complete the tasks, employee rates for time assigned to different tasks, etc. The professional services management software also includes data collected from employees indicating task statuses, time spent and assigned to tasks, information characterizing entered employee entered time (e.g., billable or not), and other information related to project and task progression in at least some cases.

The professional services management software 26 may include any type of application programs that support any type of professional services activities. For instance, the management software may include invoicing software, time entry software, project bidding software, accounting software, and many other software applications that generate and store data which defines invoices, time entries, bidding information, start and end dates, etc. In each case, the professional services management software is used to obtain, store and give access to project, invoice and/or other service related data sources. In the interest of simplifying this explanation. Unless indicated otherwise, the present invention will be described in the context of a project management software system that is used to manage work projects.

Referring still to FIG. 1, bot notification engine 32 is an application program that runs persistently and performs several functions. First, bot engine 32 monitors project and task schedules as well as other system information to identify trigger events at which times uncollected information related to project progression should be collected from different employees. For instance, one trigger may be after a first employee has worked for an entire day when no time has been assigned by the employee to any project tasks the employee was scheduled to be working on. As another instance, a trigger may be when any project spend equals or exceeds 80% of a full project budget. Many other trigger events or criteria are contemplated.

Second, bot engine 32 is programmed to generate one or more progression, time entry, or other type of notifications any time a trigger event occurs. Here, the notifications are designed to seek time entry or other program progression data or to report circumstances reflected by project management or professional services source data and to make it easy for employees to provide that data or to report current project or task statuses, or to understand project or other circumstances. In this regard, many query type notifications seeking information from employees are designed to enable employees to respond fulsomely with little effort by selecting one or more possible selectable response values from within a received notification. For instance, some query answers may be associated with touch screen selectable icons which, when selected, operate to generate response messages back to the bot engine to provide missing or relevant information. In other cases a user may have to enter text into a field to answer a query.

Third, bot engine 32 provides notifications to team applications 24 (e.g., message sender applications) in suitable formats which are transmitted to target receivers or recipients. Here, when a notification is sent to an employee as a receiver, the notification is presented within the employee's team application program so that the notification is received as if sent by another employee operating within the receiving employee's normal team application. Because most employees routinely communicate via one or more team applications, most employees should be very familiar with their own application interfaces and the way notifications are to be consumed by the employee. In the case of query type notifications, in at least some embodiments, the notifications include answer options to be selected. In these cases, the notification is presented with easy answer options (e.g., selectable icons or the like). Once an employee selects or otherwise enters an answer to a query, the answer is sent back to the bot engine.

Fourth, where an employee uses her personal computing device to generate a response to a query and transmits that response to server 20, bot engine 32 receives query answers.

Fifth, bot engine 32 runs code or instructions causing the bot engine to consume the received query answer data. Here, consumption may include recording time spent or other information received as part of the answer within a database. Consumption may also include processing the received data and, based on content received, recognizing a specific answer as a follow on trigger condition so that the bot engine generates a follow on “branch” notification to be sent via the employee's team application to the answering employee to effectively continue a dialog and solicitation of additional information when required.

Sixth, in at least some cases bot engine 32 is programmed to process data and propose project scheduling modifications or suggestions based on real project progression as well as available resources (e.g., employee time). For instance, in some cases when a project manager uses the project management software to define a new project including tasks, task schedules, resource assignments, etc., the bot engine may be programmed to identify unrealistic scheduling activities and suggest modifications based on historical employee capabilities. As another instance, where an employee indicates that a task will be completed in less time than scheduled or will require more time than scheduled or that a completion date for a task will be different than a target completion date, the bot engine may identify other scheduling options based on resource availability to either speed up project completion or to attempt to maintain a scheduled overall project completion date. The bot engine may then generate messages to employees, project managers, etc., suggesting project schedule or resource changes. The suggestions, in at least some cases, may include selectable “accept” and “reject” or other suitably labelled icons which, when selected, either reject the suggestions or interact with scheduling software to update schedules or otherwise set in motion processes to triage the project task completion process.

Referring still to FIG. 1, database 28 includes a plurality of different databases that support different aspects of the disclosed system. For instance, database 28 stores a plurality of “target source” databases which can be targeted to be examined to identify trigger conditions (or condition sets) that cause the bot engine to generate notifications. A first exemplary target source database shown is the projects database 42 that stores all project requirements, resource scheduling and resource use/allocation information for all projects that are managed via the system 10. Second and third exemplary target source databases include a time entries database 240 and a project tasks database 280. Many other target source databases are contemplated.

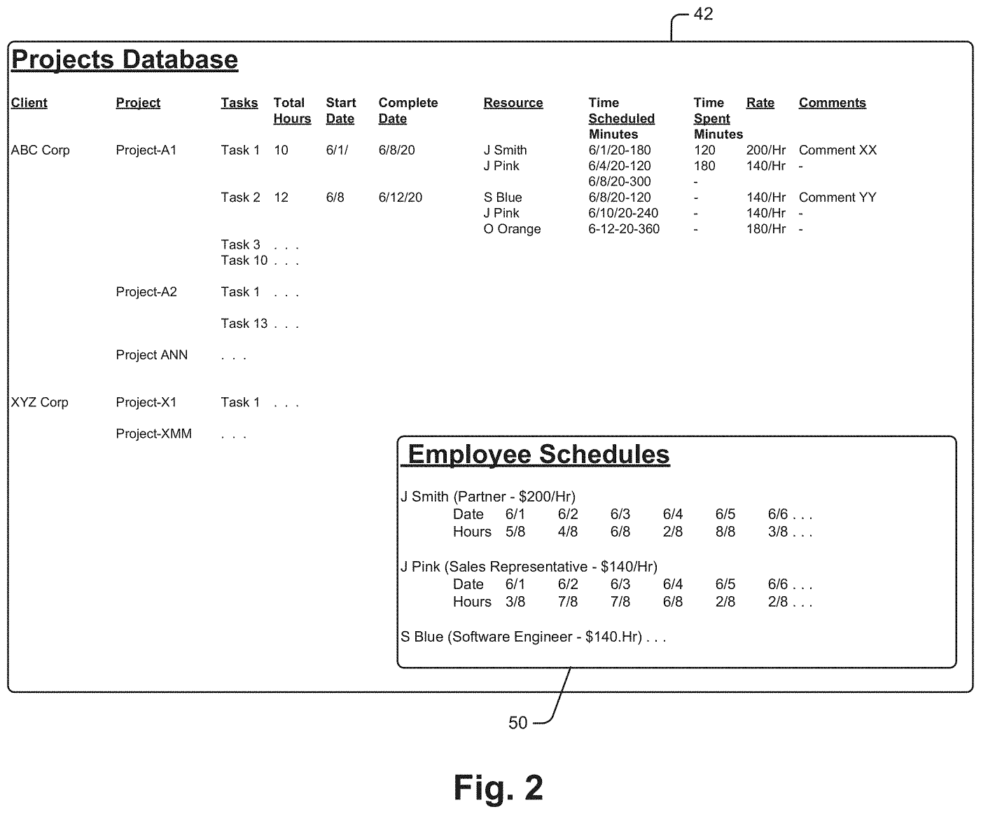

Referring to FIG. 2, an exemplary simplified project management database 28 is illustrated that includes project data arranged in a table format in the interest of simplifying this explanation and simple employee schedules. The project management table includes a “client” column, a “project” column, a “tasks” column, a “total hours” column, a task “start date” column, a task “complete date” column, a “resource” column, a “time scheduled minutes” column, a “time spent minutes” column, a “rate” column and a “comments” column. The client column lists all project management clients and includes exemplary clients ABC Corp and XYZ Corp.

Project column lists all projects for each of the clients in the client column. In the present disclosure each of the projects is considered a professional service activity and information in the database that is associate with the project will be collectively referred to as a “service record” unless indicated otherwise. For each project in the project column, tasks column lists a full set of tasks associated with the project. For each task in the tasks column, the total hours column lists hours assigned to completing an associated task in the tasks column. The start and end date columns indicate scheduled start and end dates or times for each associated task. The resource column lists employees assigned to complete at least portions of each task in the tasks column. In the illustrated example, both J Smith and J Pink are scheduled to work on task 1 for project A1 for ABC Corp. Thus, while one employee may be assigned to complete an entire task, in some cases two or more employees with different skill sets or capabilities or available time may be assigned to complete a single task.

The time scheduled and time spent minutes columns list dates that each resource is scheduled to bill at least some time to an associated task as well as the number of hours scheduled to be billed or dates and times that time is spent on each of the project tasks listed in the tasks column. As shown, employee J Pink is scheduled to work 120 minutes on Jun. 4, 2020 and 300 minutes on Jun. 8, 2020 on task 1 of project A1 for ABC Corp. The time spent minutes column is a repository for time that employees assigned to associated specific tasks worked on those tasks. Thus, in FIG. 2 it can be seen that J Smith (a resource) was scheduled to spend 180 minutes on task 1 for project A1 for ABC Corp on June 1 and logged 120 minutes while J Pink logged 180 minutes but was scheduled to only log 120 minutes on the same task. The rate column lists rates for each resource for the specific associated task. The comments column includes comments received from an employee in at least some cases in response to one or more bot engine notifications.

Referring still to FIG. 2, employee schedules database 50 includes very simple schedules for each resource (e.g., employee) that may be assigned to one or more of the project tasks. The exemplary simple schedule data includes an employee list listing all employees, their roles and their billing rates. For each employee the simplified dataset includes a date row and an hours row. The date row lists dates for each working day. The hours row list hours scheduled over total work hours available for the specific employee for an associated day. Thus, for instance, J Smith (a resource, a partner billed at $200/Hr) is currently scheduled to work 2 out of 8 total possible working hours on June 4, 8 out of 8 total possible working hours on June 5, and so on. Thus, J Smith is still available to work an additional 6 hours on June 4 if needed to perform other project tasks.

Referring still to FIG. 2, in at least some cases, if a current time is the end of the June 8 working day (e.g., 6 PM) and J Pink has not entered any time for that day, because J Smith was scheduled to spend 5 hours on task 1, project A1 for client ABC Corp, if the system is programmed to recognize no time entry by J Pink when hours were scheduled to be spent on a project as a notification trigger event, bot engine 32 may identify the trigger event and generate one or more queries in J Pink's persistent team application program that are transmitted to J Pink for consideration. Upon receiving the queries, J Pink may respond where response information is transmitted back to the bot engine and consumed by the bot engine to generate data useful in filling in the actual hours worked by J Pink for June 8 in the database 32. Many other triggers, notifications, responses, and ways of consuming those responses are contemplated.

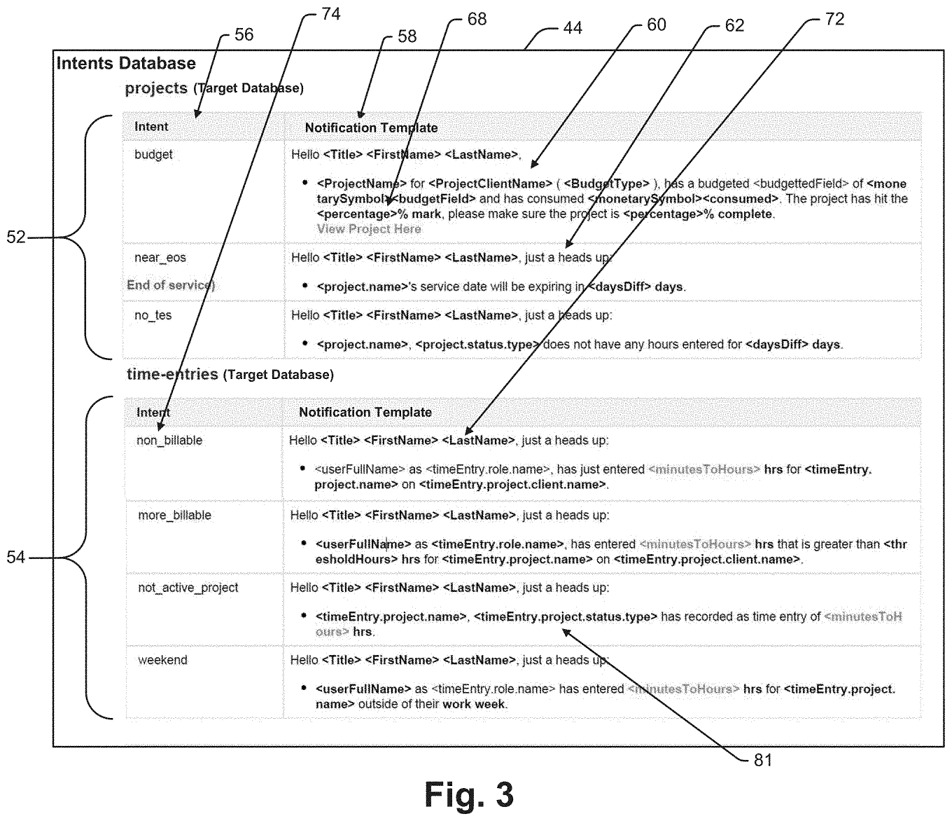

Referring again to FIG. 1, in at least some cases database 28 also includes an “intents” database 44 which stores notification templates used by bot notification engine 32 to generate query or report notifications to send to receivers. To this end, see for example FIG. 3 that illustrates a plurality of notification templates. The templates in FIG. 3 are arranges in two tables including a “projects” table 52 and a “time-entries” table 54. The projects table 52 includes a subset of templates to be used to generate notifications when the projects database 42 is a target source and a trigger condition is met by data stored in that target source. Similarly, time entries table 54 includes a subset of templates to be used to generate notifications when the time entries database 42 is the target source and a trigger condition is met by that source. While the project and time-entries database sources may be separate in some cases, in others they are combined into a single database that includes project information as well as time entry information associated with projects being managed.

Referring still to FIG. 3, the projects table 52 includes an “intent” column 56 and a “notification template” column 58. The intent column 56 lists a plurality of textual intent names or labels which can be used in notification specifications described hereafter to refer to specific ones of the notification templates in column 58 when notifications consistent with the associated template types are to be generated. For example, a “budget” intent can be used in a notification specification to access the notification template shown at 60 in FIG. 3 that is then used to construct or instantiate a notification to send to one or more receivers. The budget template is used to generate a notification when remaining budget drops to some defined value (e.g., 40% of total budget) and to encourage a receiver to consider the status of an associated project. Similarly, the “near_eos” intent can be used in a notification specification to access the notification template shown at 62 in FIG. 3 that is then used to construct a notification to send to one or more receivers. The “near_eos” template is used to generate a notification warning of a scheduled end of project date.

Referring still to FIG. 3, exemplary budget template 60 includes text segments and variable fields within arrow brackets (e.g., “<” an“>”) in which the bot engine inserts project data from a project file related to the project for which a notification is being generated or inserts information derived from that project file. Exemplary template 60 starts with a salutation “Hello” and then includes variable fields for a recipient's title (e.g., <Title>, in which a variable like “Mr., “Ms.”, etc., is inserted when a notification is generated), first name (e.g., <FirstName>) and last name (e.g., <LastName>), which are derived from a project management file associated with a notification being generated. Then the template skips a line and includes a variable field for a project name, the text “for”, a variable field for a project client's name, and so on, each of the variable fields being derived from the project management file.

At 68, template 60 includes a field requiring insertion of a percentage of a project budget that has been completed (e.g., if $8,000 out of a $10,000 budget has been spent, the percentage in field 68 would be 80%). In some cases a project management database may already store a dynamic percent of project budge spent or completed value and in that case, that dynamic value from the project budget would simply be retrieved from the project management database and be placed in field 68 when a notification is generated. In other cases it may be that an 80% (or other percent) budget spent value is calculated as part of a notification trigger determination and, in that case, the 80% value may be derived from the trigger related calculation. In still other cases the value for field 68 may be calculated via logic associated with field 68 itself and associated with the intents database 44.

In addition to text and variable fields, template 60 also includes link text titled “View Project Here” at 70 which, in operation, is hyperlinked to detailed project information for a project that is associated with a trigger event that causes template 60 to be accessed and used to generate one or more notifications. Thus, when a notification is sent to a receiver based on template 60, the notification includes a text message as well as a hyperlink to project details that the receiver can use to easily access project data.

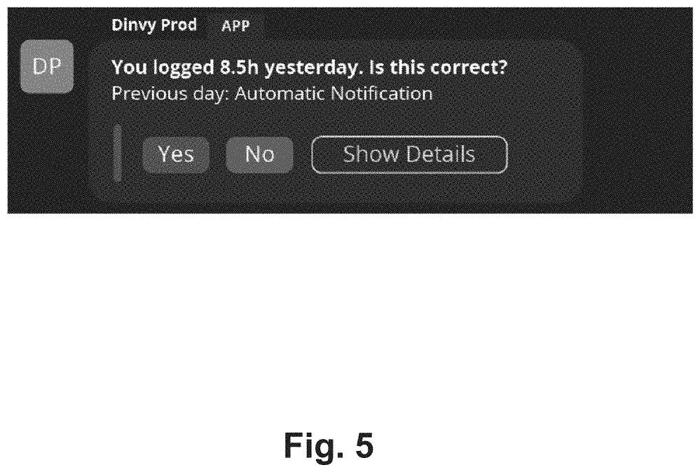

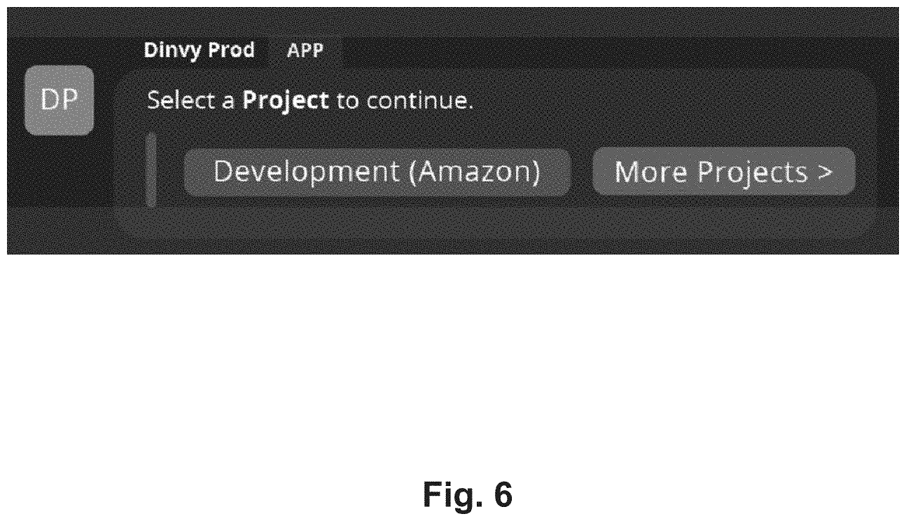

In at least some cases other types of template tools are contemplated including (i) answer options, (ii) text entry fields, and (iii) linked intents. An answer option is a tool that generates a hyperlink type selection icon within a notification generated by a persistent team application where the icon is labelled with one possible answer to a query type notification. For instance, where a template generates a notification like “You logged 8.5 h yesterday, Is this correct?”, the notification template may include first and second answer options labelled “Yes” and “No” that generate selectable “Yes” and “No” answer icons below the notification text as part of a team application notification as shown in FIG. 5. As another example, where a template generates a notification like “Select a Project to continue.”, the notification template may include answer options, one for each of several projects that the receiver is currently assigned to work on, where each of the answer options includes a label indicating identity of a project and causes the template to generate an associated selectable answer icon. See for instance FIG. 6 where a single answer option icon labelled “Development (Amazon)” is shown. In addition, in FIG. 6, a “More Projects>” icon is shown as another answer option icon which, when selected, causes the bot engine to present additional project labelled icons for receiver selection. In FIG. 6 it is contemplated that for some reason the Development (Amazon) project is the most likely project that a receiver would want to select and therefore it is presented as an initial option to expedite data entry for the receiver.

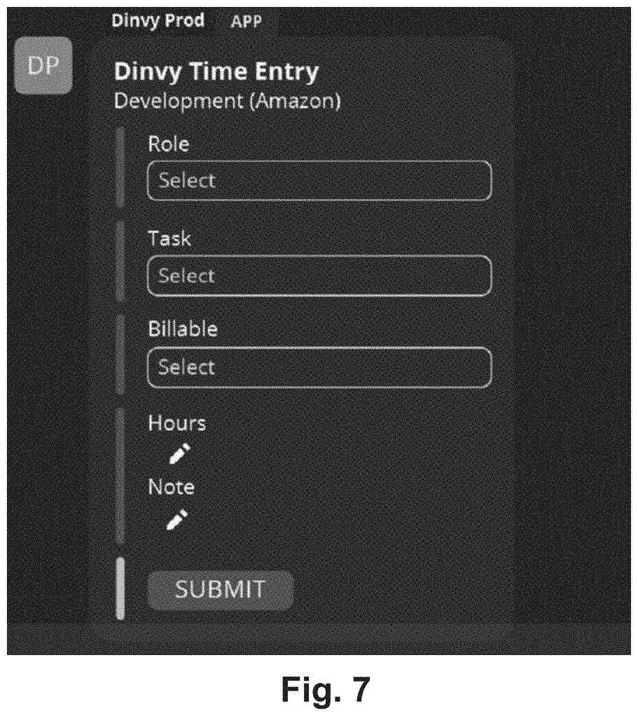

The text entry field tool that may be used in a template generates a text entry field within a query type notification sent to a receiver in which the receiver can enter text to answer a query. For instance, where a template generates a notification like “How many hours did you work on Projet-A1 for ABC Corp. today?”, the notification template may include an instance of a text entry field tool that generates a text entry field below the notification text as part of a team application notification and that enables a receiver to enter a number of hours worked on the indicated project. FIG. 7 shows an “Hours” icon that is selectable to open a text entry field for entering a number of hours worked.

In some cases a notification template may combine text entry and answer option tools to provide a pulldown menu of answer options usable to fill in a text entry field. For instance, see FIG. 7 where a “Role” field includes a “Select” option that, when selected, opens up a window of role options (not illustrated) that are selectable by a receiver to indicate the role the receiver played when spending hours on a related task. Similar pulldown menus of selectable answer options would be specified in a template and associated project database for each of the “Task” and “Billable” fields. The FIG. 7 “Submit” option is selectable to transmit query answer information to the bot engine to be consumed (e.g., entered into the project management database).

The linked intents tool or technique enables notification templates to be strung or branched together so that the string of templates generates a series of related queries to collect information from a notification receiver. For instance, in response to a receiver having not entered any time into a time entry system at the end of a work day, a first query may generate a first notification “Did you work on any projects today?” and may include “Yes” and “No” answer option icons. Here, if the receiver answers yes, that answer may be received by the bot engine and operate as an other trigger condition to cause the bot engine to link to a follow on notification template that generates a second notification “Which project did you work on?” along with four answer option icons, each labelled with a different project label corresponding to one of four projects that the recipient is currently scheduled to bill time to. If the recipient selects the second project icon, that answer may operate as yet another trigger condition and cause the bot engine to link to another follow on notification template that generates a third notification akin to the notification shown in FIG. 7 where more detailed information related to the billed time is collected.

In all query notification cases where a receiver provides information to the system in response to a received notification, the response causes the system to generate a message to be sent back to the system server via the persistent team application (e.g., Slack message sender or other) used to send the notification to the receiver where the response message includes information provided by the receiver (e.g., the answer(s) to a question(s)). Upon receiving answer information, the bot engine consumes that information by at least one of (i) storing the answer(s) in the project management database and/or (ii) using the answer(s) to link to a next branching notification template. In cases where the bot engine links to a next notification template in response to receiving specific answer information, the answer information operates as a trigger event for the next template and associated notification.

In addition to causing a branch follow on notification to be sent to a receiver that responds to a prior notification, the receiver's response (or lack of a response) may also be the trigger condition or one of several trigger conditions that result in other notifications sent to other system users. For instance, if a first employee responds that she did not bill any time on any projects for an entire day, that response may operate as a trigger condition for the bot engine to instantiate and send a notification to the first employee's project manager. If a first employee's response to a query is that the first employee has additional bandwidth to take on more project tasks now or at some other future time, that response may operate as a trigger condition for the bot engine to generate a plurality of notification to send to a plurality of project managers so that those managers can assess how best to use the first employee's unexpected excess time. Many other branching notification paths are contemplated.

In other cases, instead of using recipient answers/responses as trigger conditions to access other independent notification templates, it is contemplated that a single multi-level notification template may be defined that includes a first level template including answer options and second level notification templates associated with at least some of the answer options as needed within the single multi-level template. Thus, for instance, the single multi-level template may specify a first level template including text and variable fields to instantiate a first query as well as four answer options to the first query and four second level templates, one of each of the answers, to instantiate follow on notifications depending on which answer is selected by a receiver. In some cases it is contemplated that at least some receiver answers will only comprise a single trigger condition in a multi-trigger condition set and that the system server will only generate a follow on notification upon receiving the answer and identifying the other trigger conditions in the set within one or more of the system databases.

While only three templates associated with a “projects” source and four associated with a “time-entries” source are illustrated in FIG. 3, it should be appreciated that in a workable system, many other templates would be defined in database 44 for each of the projects and time-entries sources and that there may be many other database sources to which many other specific templates apply. For instance, it is contemplated that there may be several hundred templates specified in the Intents database 44 for each of ten, one hundred, or even thousands of different data sources. Again, other exemplary source types may include, for instance, any type of dynamic database where content changes over time including, for instance, separate databases related to project tasks, invoices, project quotations, accounting activities, etc. To be clear, the templates and related sources shown in FIG. 3 are only exemplary and in a working system many more templates and database sources would be provided.

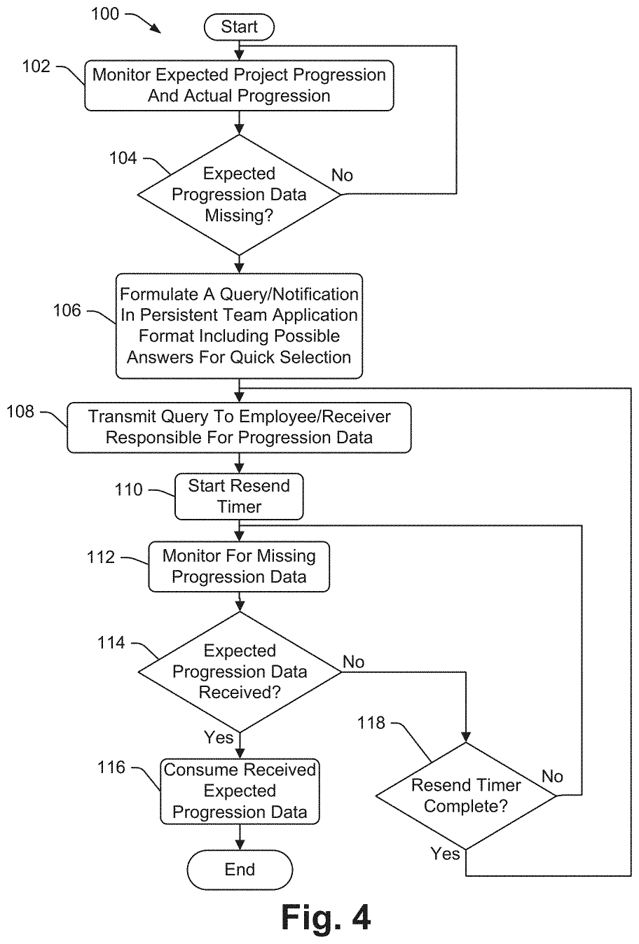

Referring now to FIG. 4, a simplified process 100 that is consistent with at least some aspects of the present invention is shown where the system tracks employee time entries and if expected entries are missing, generates notifications in an attempt to obtain time entry information. In this example it is assumed that the projects database 40 in FIG. 2 is the target source to be examined to identify trigger conditions. At block 102 a bot notification engine monitors expected project progression and actual progression as stored in the FIG. 2 database. At block 104, if expected progression data is not missing, control loops back up through block 102.

Once expected data is missing at 104, a notification trigger occurs and control passes down to block 106 where the bot engine formulates a notification/query in a format useable by the persistent team application which includes easy to select possible answer option icons for selection by an employee. At 108 the bot engine transmits the query to the employee responsible for entering the progression information (e.g., to a receiver). At 110 the bot engine starts a resend timer (e.g., 5 minutes to 2 hours depending on preferences). At block 112 the bot engine monitors for messages received back from the persistent team application including missing progression data. Where expected progression data is received, the bot engine consumes that data at 116 and fills in part of the actual hours data set or other database data as appropriate.

Referring again to FIG. 4, where expected data is not received at block 114 control passes to block 118 where the bot engine determines if the resend timer has timed out. If the timer has not timed out control continues to loop through blocks 112 and 114 until expected data is received. At block 118, if the timer is timed out, the bot engine transmits another query to the employee seeking the missing data and the timeout process is repeated if necessary.

While not shown in FIG. 4, in other cases other messages may be generated periodically and sent to one or more employees including, for instance, noncompliance messages to project managers, possible schedule or resource requirement changes to managers or other employees responsible for other tasks or available to help complete tasks, etc.

FIGS. 5 through 7 show exemplary bot notifications delivered to an employee via the employee's persistent team application program as pop-up messages and prompts to enter time entry data when associated trigger events occur. In FIG. 5, the trigger event that results in the message is that time was logged by an employee but insufficient information was entered by the employee to assign the time to a specific task. The query is “You logged 8.5 h yesterday. Is that correct?” Template specified answer option icons include “Yes” and “No” that are presented as on screen selectable hyperlinks within the notification. In addition, a “Show Details” icon is presented which is selectable to access and present details related to the logged time. In the present example, if the employee selects “Yes” in FIG. 5, upon receiving that response the exemplary bot engine uses that response as a trigger to branch to a next notification template which is used to instantiate a follow on notification like the one shown in FIG. 6 which is then automatically transmitted to the employee to obtain additional information related to he entered time.

In FIG. 6, the notification seeks to obtain information to associate the logged time with a specific client and project and includes the text notification/instruction “Select a Project to continue.” As shown, the notification may present a most likely project to be selected in an on screen icon where most likely may be, for instance, determined from prior recently billed time, the employee's schedule (e.g., which project the employee was scheduled to be working on), etc. Other projects are accessible via the selectable “More Projects>” icon. In FIG. 6, if the most likely project is selected, the bot engine may use that selection as yet another trigger condition to branch to a next notification template to generate the follow on query shown in FIG. 7.

In FIG. 7, the query seeks to obtain information specifying the employee's role while spending the 8.5 hours on the project, the task(s) performed by the employee, information on if the time spent is all billable or not and other information. Thus, for instance, a first employee may be able to operate in multiple roles such as, for instance, a sales representative, a software engineer, an auditor, etc., and in those cases the bot engine seeks an indication of which role the employee operated while billing time. Each of the role, task and billable sub-queries includes a selectable field to open drop down menu options for generating quick responses.

In addition to providing project status reports and seeking new or missing data to populate a database, at least some aspects of the present disclosure are related to a system that enables users to customize project tracking, data gathering, and notification systems to meet personalized preferences or requirements for specific project management entities (e.g., employers, employees, project managers, etc.). Here, in at least some cases a programmer can determine types of notifications generated and notification receivers/recipients. In some cases a programmer can also specify specific trigger events/conditions for notifications as well as times when triggers should be checked and/or times when notifications should be transmitted to receivers.

In at least some embodiments a simple software based text editor interface is provided for a programmer to specify trigger conditions, notifications, and notification recipients. To this end, while many different types of text editors may be employed, the present disclosure will be described in the context of a JavaScript Object Notation (JSON) editor (hereafter “text editor”) where a notification bot engine is programmed to use user defined notification specifications to generate and transmit notifications to specified recipients. In at least some embodiments each notification specification requires a programmer/programmer to identify several different types of information including a source database or databases that are to be examined for trigger conditions, trigger conditions that require notification, which notification(s) to generate when specific trigger conditions occur, and system users to receive notifications when trigger conditions occur (hereafter “receivers”).

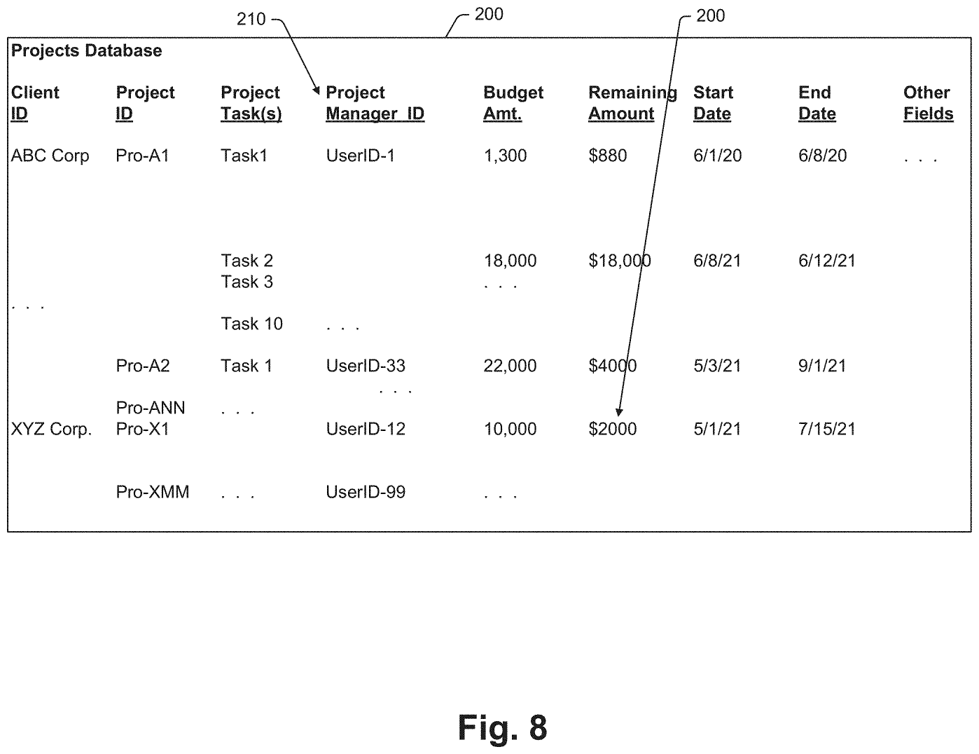

FIG. 8 shows a second version of a projects 200 akin to the database shown in FIG. 2, albeit storing different data sets for each project being managed, which may operate as a source database for an exemplary notification system. The simplified yet exemplary database 200 includes client ID, project ID and project task(s) columns akin to those described above with respect to FIG. 2. In addition, database 200 includes a project manager ID column, a budget amount column, a remaining amount column, and start and end date columns. The project manager ID column lists a character string identifier (represented in simplified form via labels “UserID-1”; “UserID-33”, etc.) for each manager of each project listed in the project ID column that is useable within the system to identify a specific task manager. While a single task manager is listed for each project, in some cases two or more managers may be listed or different managers may be listed for different tasks corresponding to a single project. The budget amount column lists a separate budget amount for each task listed in the project tasks column and may also or instead list a separate full project budget amount per project. The remaining amount column lists the amount of budget that remains or that has not yet been spent. The start and end date columns list scheduled start and end dates for each of the projects and each project task listed in project and task columns. Many other project management data columns may be provided in the database 200 in at least some embodiments.

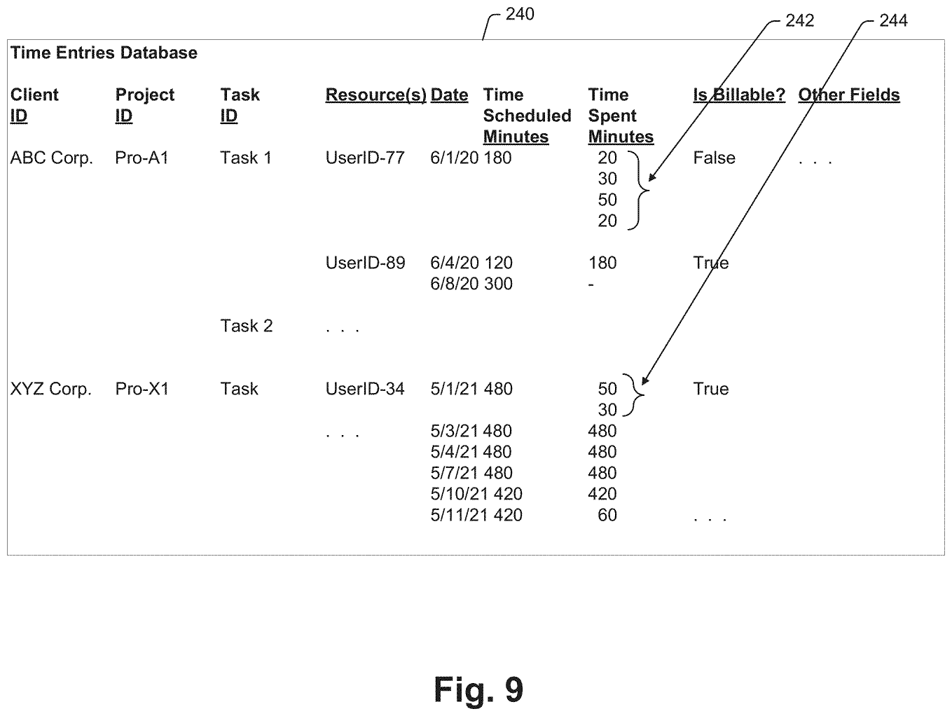

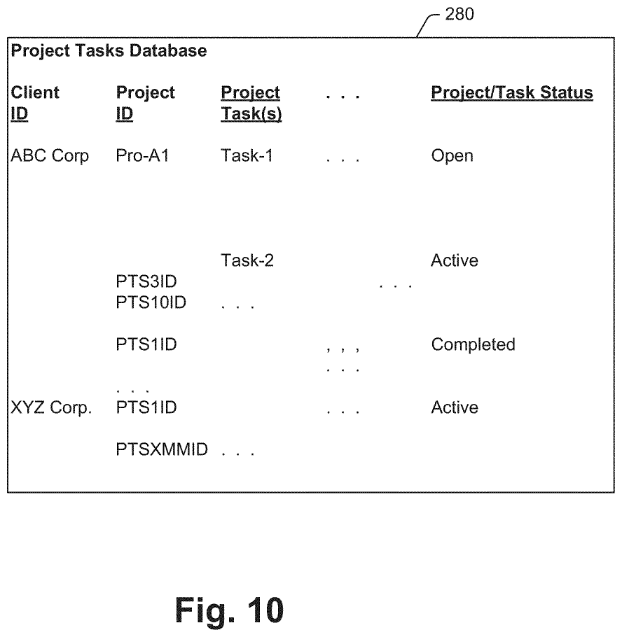

Two other exemplary source databases are illustrated including a time entries database 240 shown in FIG. 9 and a project tasks database 280 shown in FIG. 10. Time entries database 240 includes client ID, project ID and Project Task(s) columns as in the FIG. 8 database. Database 240 also includes a resources column that lists all system users (e.g., resources) that are scheduled to bill time to each task in the task ID column. A “date” column lists all dates on which resource time is either scheduled to be billed to a project task and/or a date when time has been billed to a task. A “time scheduled minutes” column records the amount of scheduled time for each task and a “time spent minutes” column records actual time each resource spent working on an associated task. An “is billable?” column includes an indicator of whether or not time reported as spent on a task is actually billable (e.g., exemplary entries include true or false). Again, many other columns of time entry data may be included in database 240 and the data shown is only exemplary and has been minimized in the interest of simplifying this explanation.

Project tasks database 280 shown in FIG. 10 is shown in a very abbreviated form where most of the data that would be included in the database is now shown in the interest of simplifying this explanation. To this end, database 280 is shown to include client ID, project ID and Project Task(s) columns as in the FIG. 8 database and also includes a task status column that indicates if project tasks are open, active or completed. Many other statuses are contemplated and many other columns of related data are also contemplated.

The FIG. 8-10 databases are only exemplary and the system may include many more and, in fact, an infinite number of source databases that can be examined to identify trigger conditions. For instance, other exemplary databases may include an invoices database, a project quotation database, a project notes database, a project accounting database, etc. The idea here is that other software applications that already exist for other project management, invoicing, time entry, or other purposes already generate databases including data that can be examined to identify interesting conditions or trigger conditions that warrant one or more notifications to one or more system users and that these databases can be used “as is” by the notification bot engine if they are targeted as sources for examination.

While databases generated by other software applications can be examined in the forms that they are maintained by those applications, in other cases a system server may mine specific data from specific databases and create one or more databases with combined datasets that are specifically designed to efficiently drive disclosed notification systems. For instance, in some cases the projects, time-entry, and project tasks databases in FIGS. 8-10 may be combined into a single database.

In some cases it is contemplates that a system server may be programmed to derive new data from data that already exists in one or more source databases where the new data is required as a trigger condition for at least one notification specification or to instantiate at least one instance of a notification to be transmitted to a receiver. For instance, in a case where a notification is to be sent to any project manager when only 20% of a full initial project budget remains (e.g. 80% has already been spent), a server may be programmed to calculate a % budget remaining value for each ongoing project and to store that value in a projects database or some type of supplemental database maintained by the server as an additional database to operate as a source to be examined. The server may derive and store many other project related data values to drive the disclosed bot engine.

Each of the columns in a source database corresponds to a field where data in each field or data in a plurality of fields can be used to identify one or more trigger conditions causing the bot engine to generate one or more notifications. For instance, in FIG. 8, the start date column corresponds to a start date field where values in that column can be examined to see if a trigger condition related to project or task start date has been met. For example, in a case where a project manager wants to access all projects that are scheduled to start Jun. 15, 2021, a trigger condition would include a start date of Jun. 15, 2021 causing a system processor to access all projects that have that start date in the start date column and would generate one or more notifications including information on projects scheduled to start on that date.

In addition to basing trigger conditions on values in the field columns, more complex trigger conditions are contemplated. For instance, in a case where a project manager wants to access all projects that are scheduled to start on or after Jun. 15, 2021, a trigger condition would include a start date of Jun. 15, 2021 or after that date causing a system processor to access all projects that have that start date or later in the start date column and would generate one or more notifications including information on projects scheduled to start on or after that date.

As another example, a trigger condition may be that 20% or less of a scheduled project budget remains. Here, referring again to FIG. 8, to check this trigger condition, a system processor would compare the value in the remaining amount field with the value in the budget amount field for each project and identify all projects where the remaining amount is 20% or less than the budget amount.

To define and then recognize complex trigger conditions the bot engine is programmed to support (e.g., recognize and consume) a plurality of different operations. value types and other data expressions. Regarding operations, at least some operations include a relational condition expressed as a text statement that is applied to two values, a first value being a trigger value and a second value existing within a source database. For instance, in a case where a manager wants notifications for all projects with a start date equal to Jun. 15, 2021, the system supports an “equal” operation which can be used to express a trigger when a project start date in a source database is “equal” to a trigger value of Jun. 15, 2021. As another instance, in a case where a manager wants notifications for all projects with a start date of Jun. 15, 2021 or after that date, the system supports an “atleast” operation which can be used to express a trigger when a project start date in a source database is “at least” a trigger value of Jun. 15, 2021 or later. As yet one other instance, another operation supported by at least some embodiments of the present disclosure is “atmost” which can be used to recognize when a remaining budget value is “at most” a trigger value of 10% of a full budget amount. Other exemplary operations that can be recognized by a bot engine include but are not limited to the following:

Less_than

Greater_than

Any

Not_equal

Between

Within

Notnull.

Value types supported by an exemplary system include text, number, day, boolean, and percentage. Text means that a value that is expressed in a related trigger condition is simply the text that is specified in the condition. For instance, if a value for “is billable?” is “true”, the value in a source database corresponding to an “is billable?” column has to include the text “true”.

Number means that a number expressed in a trigger condition is a numerical value (e.g., “10” means the number 10 as opposed to a text representation). Day means that a value expressed in a trigger condition corresponds to a specific date that is then fit into a calendar for purposes of identifying the specific date or related dates. Percentage means that a related number specified in a trigger condition is a percentage (e.g., 10 means 10%). Other value types are contemplated.

Data expressions supported by the bot engine and that can be included in notification specifications include time or period related expressions and, in at least some cases, include the following or at least a subset of the following. Assuming the current date in Mar. 31, 2021, the time based expressions would mean the following.

| Data Expression | Converted Value |
|---|---|
| Now | Mar. 31, 2021 |
| Today | Mar. 31, 2021 |
| Tomorrow | Apr. 1, 2021 |
| Yesterday | Mar. 30, 2021 |
| Week | Apr. 7, 2021 |
| Month | Apr. 30, 2021 |
| Year | Mar. 21, 2022 |
| Start_of_week | Mar. 28, 2021 |
| End_of_week | Mar. 31, 2021 |
| Start_of_month | Mar. 1, 2021 |
| End_of_month | Mar. 31, 2021 |
| 1 week | Apr. 7, 2021 |
| 2 weeks | Apr. 14, 2021 |
| 3 weeks | Apr. 21, 2021 |
| Month | Apr. 30, 2021 |
| 10 days | Apr. 10, 2021 |
| 4 days | Apr. 4, 2021 |

In at least some embodiments a programmer of a disclosed system using a computer with a keyboard and a display screen that is familiar with a limited set of text editor syntax rules and notification specification requirements can define a notification specification causing automatic notifications to be generated and transmitted to receivers when information in one or more source databases is consistent with trigger conditions defined in the notification specification. The simple exemplary JSON syntax includes a key in quotes and related value in quotes separated by a colon (e.g., “key”:“value”). In at least some embodiments this simple syntax is used to specify each information subset needed to fully define a notification specification. To this end, each notification specification requires (i) a target source database to which trigger conditions can be compared or applied, (ii) defined trigger conditions, (iii) information that specifies one or more receivers (e.g., system users to receive notifications when they are generated), and (iv) information indicating the content to be included in each notification generated.

Using JSON syntax, a “projects” database (e.g., see again FIG. 8) may be specified as a data target source to examine using trigger conditions via the following expression:
“source”:“projects”
   Similarly, a time entries database like the one shown in FIG. 9 can be specified as a target data source via the following expression:
“source”:“time_entries”
   Other sources can be targeted for trigger examination in a similar fashion.

Regarding trigger conditions, a simple singular trigger condition can be specified by indicating an operation, a value type, a value, and one or more source database fields depending on the operation included in the condition. For instance, a trigger condition that occurs when remaining budget amount for a project is equal to $2000 may be specified via the following expression:

“conditions”: [
{
“operation”:“atmost”,
“value_type”:“text”,
“value”:“2000”,
“field”:“remaining_amount”
}
]

Here, “conditions” operates as a trigger key and the expressions in “{ }” brackets operate as a “value” for the conditions trigger key. Within the “{ }” brackets, “operations” is a key and “equal” is a value for the operations key meaning that a remaining amount value in a target database for a project has to be “at most” $2000. “Value_type” is a key and “text” is a value for the value_type key, etc. To check this trigger condition, a system processor checks if a remaining budget amount in the target database is equal to or less than $2000 and, if the remaining budget amount is equal to or less than $2000, the trigger condition is met.

As another instance, a trigger condition that occurs when remaining budget amount for a project is 20% or less (e.g., is at most 20%) of an initial full project budget may be specified via the following expression:

“conditions”: [
{
“operation”:“atmost”,
“value_type”:“percentage”,
“value”:“20”,
“field”:“remaining_amount”,
“secondary_field”:“budget_amount”
}
]

Here, the “percentage” value type means that the “20” associated with the value key is a percentage and the “field” and “secondary field” values indicate database data to use as a numerator and a denominator in a percentage calculation, respectively, performed by a system server to derive a database value to be compared to the 20% trigger value expressed in the conditions statement.

Dual trigger conditions requiring (i) remaining budget amount for a project to be $2000 or less and (ii) remaining budget amount for a project to be 20% or less of an initial full project budget may be specified in an array structure with a series of conditions, each in “{ }” brackets with a comma between each separate condition via the following expression:

“conditions”: [
{
“operation”:“atmost”,
“value_type”:“text”,
“value”:“2000”,
“field”:“remaining_amount”
},
{
“operation”:“atmost”,
“value_type”:“percentage”,
“value”:“20”,
“field”:“remaining_amount”,
“secondary_field”:“budget_amount”
}
]

A trigger condition that occurs when remaining budget amount for a project is any of $5000, $2000 or $1000 may be specified via the following expression:

“conditions”: [
{
“operation”:“any”,
“value_type”:“text”,
“value”:“1000, 2000, 5000”,
“field”:“remaining_amount”
}
]

A trigger condition that occurs when a project start date is between Jan. 1, 2021 and Jan. 30, 2021 may be expressed as:

“conditions”: [
{
“operation”:“between”,
“value_type”:“text”,
“value”:“2021-01-01,2021-01-30”,
“field”:“start_date”
}
]

A trigger condition that occurs when a project has not been completed may be expressed as:

“conditions”: [
{
“operation”:“not_equal”
“value_type”:“text”,
“value”:“completed”,
“field”:“status”
}
]

Here, to check the trigger condition, a system processor checks in a source database if a project status is completed and, if the status is “not equal” to “completed”, the trigger condition is met.

Many other trigger conditions are contemplated that can meet any administrator/programmer notification needs and/or preferences.

Regarding notification receivers (e.g., system users that receive notifications when trigger conditions occur), JSON syntax may be used to specify a specific user to receive a notification via the following expression:

“receiver_ids”:
[
“UserID-77”
]

Where “UserID-77” is a simplified representation of a string of numbers and letters uniquely identifying a system user that operates as a value for the “receiver_ids” key. Two specific receivers associated with user identifiers UserID-77 and UserID-89 can be specified via the following expression:

“receiver_ids”:
[
“UserID-77”,
“UserID-89”
]

Where two user identification numbers are separated by a comma.

In the above two examples where receivers are specifically identified, the audience type for an associated notification is said to be “static” meaning that the receivers do not change depending on which projects in a database meet trigger conditions. For instance, it may be desirable for a high level project manager to receive notifications for each project, regardless of which of several project managers is managing each project, when fees accrued to the project exceed the full project budget by 5% or more. In this case, by specifying the identification number for the high level manager, that manager would receive a separate notification for each project where accrued fees exceed budget by 5% or more.

It has been recognized that, in many cases, instead of targeting specific receivers for specific notifications, it is advantageous to be able to target a class of system users to receive some notification types so that any time a user of a specified class is associated with a project, that user receives notifications when trigger conditions for the project occur. For instance, it may be that a specific entity employs 20 project managers that each manage different projects and that the entity wants each of the 20 project managers to receive a notification every time one of their projects has 20% or less of an initial total project budget remaining. Instead of requiring specification of a separate notification specification for each manager, at least some embodiments of the disclosure enable a programmer to specify a “dynamic” audience type where, when a notification trigger condition occurs for a specific project, a system server identifies any users associated with the project that are of the class of users that is to receive the notification and then generates and transmits a notification to each of the identified users. Here, the server relies on a pre-existing database that specifies which users are associated with which projects and the use's roles related to the projects and therefore there is no need to specify specific notification receivers in a notification specification. Instead, when trigger conditions are met, a bot engine automatically identifies receivers in the database that are of a class specified in the notification specification.

In at least some embodiments a dynamic audience type and audience classification including all project managers may be specified via the following expressions:
“audience_type”:“dynamic”
“audience”:“project_manager”

JSON syntax can also be used to specify notification content by specifying one of the notification templates stored in intents database 44. For instance, to specify a budget notification consistent with budget template 60 shown in FIG. 3, a programmer can enter the following expression.
“intent”:“budget”
   Here, when data in the projects source database satisfies trigger conditions, the bot engine accesses notification template 60 associated with the budget intent in FIG. 3 as well as other databases that store data needed to fill in the variable fields in the template or to derive values needed to fill in those fields and derives any required values and then populates the variable fields with the data and derived values to instantiate an instance of a notification. The notification is provided to a receiver's team messaging application and is transmitted to the receiver.

As another instance, to specify a “not active project” notification consistent with template 81 shown in FIG. 3, a programmer can enter the following expression.
“intent”:“not_active_project”
   Here, when data in the time entries source database satisfies trigger conditions, the bot engine accesses notification template 81 associated with the not active projects intent in FIG. 3 as well as other databases that store data needed to fill in the variable fields in the template or to derive values needed to fill in those fields and derives any required values and then populates the variable fields with the data and derived values to instantiate an instance of a notification. Again, the notification is provided to a receiver's team messaging application and is transmitted to the receiver.

In at least some cases the same intent value (e.g., non-billable or budget, etc.) may exist for two or more target databases and, in that case, a processor processing a notification specification may be programmed to select whichever intent is associated with a target database specified in a notification specification. Thus, for instance, assume that a first “non-billable” intent exists in FIG. 3 (not illustrated) for the projects target data and a second “non-billable” intent exists in FIG. 3 (see 74) for the time entries target data. In that case, if a notification specification specifies the projects target database and the non-billable intent, the template corresponding to the projects source and non-billable intent would be selected and, if a notification specification specifies the time entries target database and the non-billable intent, the template corresponding to the time entries source and non-billable intent would be selected to generate notifications.

Thus, all notification specification requirements can be specified simply via a JSON or other simple text syntax entered as text by a programmer via a computer.

At this point, some simple examples of complete notification specifications that a programmer may enter using a JSON text editor are instructive. Consider the following JSON text entry.

Example 1

{
“source”:“projects”,
“intent”:“budget”,
“conditions”:
[
{
“operation”:“atmost”,
“value_type”:“percentage”,
“value”:“20”,
“field”:“remaining_amount”,
“secondary_field”:“budget_amount”
}
],
“receiver_ids”:[“UserID-69”],
“audience_type”: “static”
}

Here, the idea is to send a budget related notification to a system user identified by receiver ID number “UserID-69” when a trigger condition occurs where the trigger condition is that a remaining budget amount (e.g., remaining amount) indicated in the projects database is equal to or less than (e.g., at most) 20% of the original full project budget. To this end, the text defines the source as the projects database, the “intent” is “budget” meaning that the budget template 60 (FIG. 3) is to be sent to the specified recipient, the conditions specify remaining_value (e.g., “field”, which indicates the denominator of the percentage) is at most (e.g., operation is “atmost”) 20% (e.g., value type is percentage and value is 20) of the budget value (e.g., secondary_field which indicates the denominator of the percentage). The user to receive the notification is specified by the user ID in the value associated with the receiver_ids key. Thus, the text expression entered using the simple text editor interface specifies the target source database, trigger conditions, a notification receiver, and the type of notification (e.g., notification content) to be sent to the receiver.

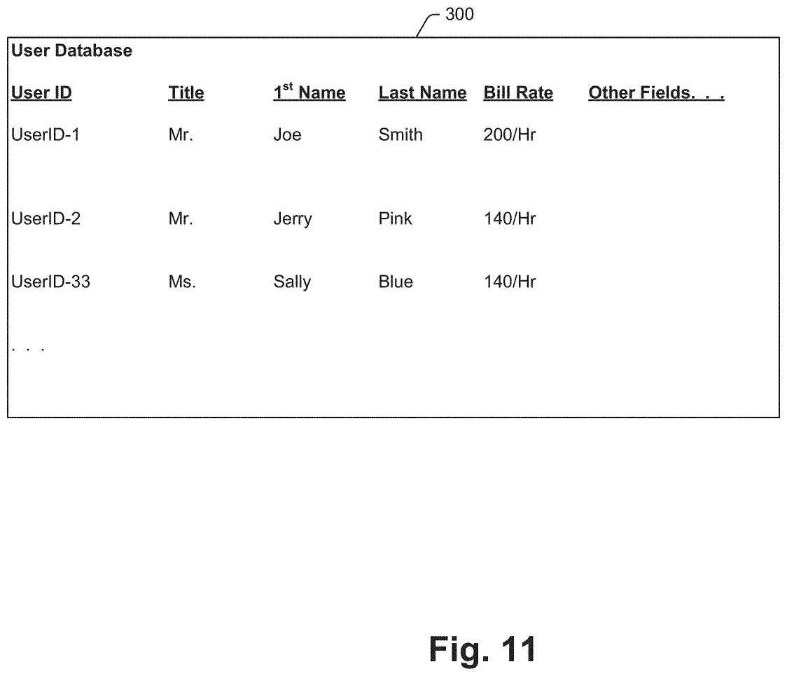

Regarding the notification type, see again FIG. 3 where exemplary notification types are illustrated including a “budget” notification corresponding to the “projects” database. In this case, when the specified trigger conditions occur for a specific project, a notification instance based on template 60 associated with the “budget” intent is generated and transmitted to the recipient. Again, to generate a notification, the bot engine may access other system databases to obtain other information needed to fill in notification variables. For instance, the notification specification shown in Example 1 above only includes a recipient's ID, not the recipients first and last name and title which are required in the budget notification template 60 in FIG. 3. Thus, a system server may access a different user database 300 (see FIG. 11) that correlates user IDs with titles, names, and other user information in order to instantiate a complete notification instance.

It should be appreciated that the notification specification shown in Example 1 above may generate notification instances corresponding to none, one, or many projects that are sent to the recipient (UserID-69) identified in the notification specification. To this end, once activated, the trigger conditions specified in the notification specification above are persistently (e.g., every 15 minutes) applied to the entire projects database (e.g., all projects having data in the database) and therefore, in theory, could generate a separate notification for each of the projects represented in the database if the trigger conditions are met for each of the projects. Thus, the disclosed system enables a programmer to define a single notification specification that is then applied to large numbers of projects so that the single specification can be used to generate notifications for many projects as opposed to a single project when desired.

Referring again to the above text entry Example 1, at the end of the entry an “audience_type” key is assigned a “static” value. Here, the “static” value means that the receiver is always the same individual that is specified by the value assigned to a “receiver_ids” key. Thus, in Example 1, the receiver is persistently the user associated with the UserID-69 identifier.

Next, consider the following JSON text entry that specifies another complete notification specification.

Example 2

{
“source”:“projects”,
“intent”:“budget”,
“conditions”: [
{
“operation”:“atmost”,
“value_type”:“text”,
“value”:“2000”,
“field”:“remaining_amount”
},
{
“operation”:“atmost”,
“value_type”:“percentage”,
“value”:“20”,
“field”:“remaining_amount”,
“secondary_field”:“budget_amount”
}
],
“audience_type”: “dynamic”,
“audience”:“project_managers”
}

In example 2, the idea is to send a budget related notification to each project manager for each project that the manager manages when a trigger condition occurs where the trigger condition requires both (i) that the remaining budget is $2000 or less and (ii) the remaining budget is 20% or less of the full initial budget for the project. The audience in this case includes all managers as specified by the dynamic audience type where the audience includes “project managers”. Thus, here, if the trigger conditions occur for a specific project, a system processor identifies the “budget” template 60 in FIG. 3 and accesses other databases to obtain additional data needed to fill in the template variables to create a notification instance and then identifies one or more project managers for the project in the projects database (see 210 in FIG. 8) and provides the notification instance to the manager's persistent team messaging application to be transmitted to the manager.

Consider the following JSON text entry that specifies yet another complete notification specification.

Example 3

{
“source”:“time_entries”,
“intent”:“non-billable”,
“conditions”: [
{
“operation”:“equal”,
“value_type”:“text”,
“value”:“false”,
“field”:“is billable”
}
],
“audience_type”: “dynamic”,
“audience”:“project_managers”
}

In this third example, notifications are sent to any project manager for any project managed by that manager where time recorded to the project in the time entries target data source (e.g., FIG. 9 in the present specification) is non-billable.

Thus, using a JSON or other simple text editor type interface, a programmer can specify many different notification specifications to meet system user and entity preferences and unique requirements given different target data types.

While it makes sense for notifications to report out the occurrence of trigger conditions or at least be somewhat related thereto, it should be appreciated that the a programmer may select any notification template for generating notifications irrespective of which trigger conditions are specified in a notification specification in at least some disclosed embodiments. For instance, in a case where trigger conditions require at most 20% remaining budget, in one case a first notification template may report out the % budget remaining and in another case a second notification template may simply indicate that the project remains within budget. In a third case, a third notification may simply indicate that the project is active and not report that the remaining budget is at most 20%. While the third notification is minimally tethered to the trigger condition, the point here is that the notification can be any type irrespective of associated trigger conditions in at least some embodiments of the disclosed system.

In the examples above, programming keys supported by the disclosed system are described including, for instance, “source”, “audience_type”, “audience”, “receiver_ids” and “conditions”, where condition keys further include “operation”, “value_type”, “value”, “field”, and “secondary field”. Other keys and related schema are contemplated that are used in notification specifications for different purposes.

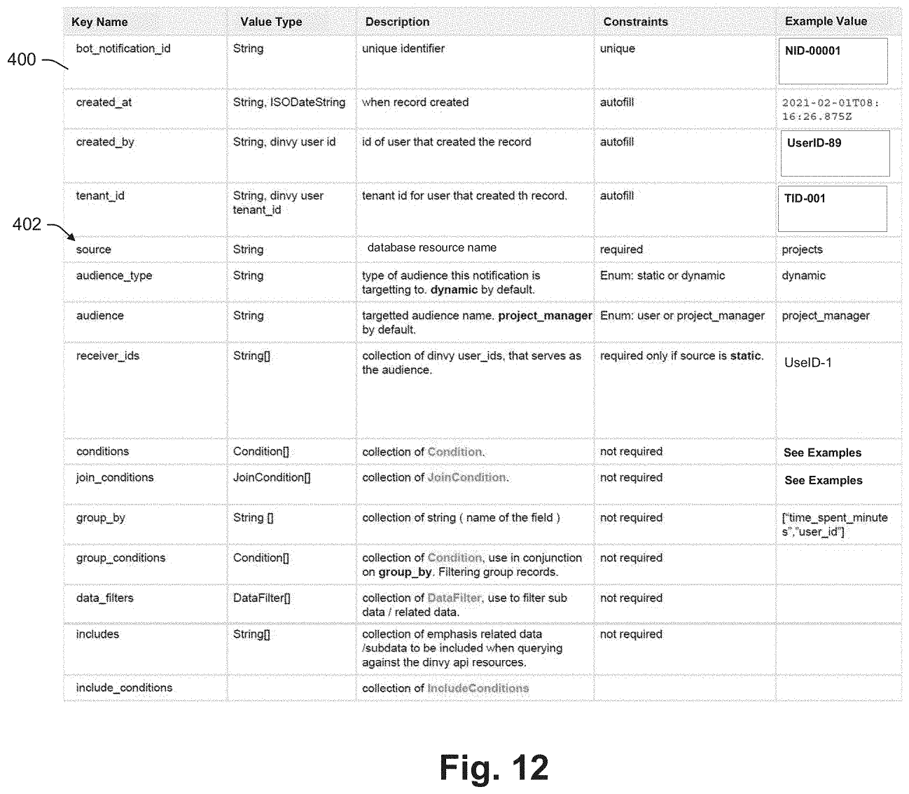

FIG. 12 includes a key and schema table 400 that lists a more fulsome set of keys and related schema information that are supported by the exemplary bot engine including those identified above and others that are usable to define notification specifications. For each key, the table includes a key name, a data type for the value to be associated with the key name, a description of the value, any constraints on the value, and an exemplary value that may be associated with an instance of an associated key. For instance, for the “source” key (also described above) at 302, the value type is a text string, the description indicates that the source is a name of a target data source to which trigger conditions are to be applied, the constraints indicate that a source is required (e.g., needs to be specified for a notification specification to be defined) and an exemplary target source value indicating the source to which trigger conditions are to be applied is shown as “projects”. Again, using the JSON syntax, the projects source is specified as “source”:“projects”.

As another example, for the “created_by” key, the value type is a string and the string comports with a format for a user identification number and the description indicates that the value associated with the key identifies the user that created the record or notification specification. The constraints indicate that the user identifying number is automatically filled in when the notification specification is created or at least stored. Here, for instance, when the user associated with UserID-89 specifies a notification specification, the system may automatically identify the user via UserID-89 and add that information to the specification via an expression like:
“created_by”:“UserID-89”
   The exemplary user ID value in FIG. 12 is “UserID-89”. Other key types for memorializing information associated with the creation of a notification specification and that are automatically filled in when a new notification specification is created include the “created_at” and “tenant_ID” keys which indicate date and time a specification was created as well as a tenant that employs the user that created the specification.

In some cases it may be that a notification should be automatically generated when data in a first source database meets a first trigger condition and data in a second source database meets a second trigger condition. For example, it may be that a notification should be automatically generated and sent to any project manager managing of any project where entered time is non-billable and the project is active. Referring again to FIGS. 9 and 10, the billable or not characterization of entered time can be accessed in the time entries database (FIG. 9) while the project status can be accessed in the project tasks database (FIG. 10). To specify different data sources for different trigger conditions in one notification specification, the disclosed system uses a “join_conditions” key (see again FIG. 12) which can be used to specify a second or more source databases using JSON syntax. For example, the dual source notification described above may be expressed as follows.

Example 4

{
“source”:“time_entries”,
“audience_type”:“dynamic”,
“intent”:“non_billable”,
“audience”:“project_manager”,
“conditions”: [
{
“operation”:“equal”,
“field”:“is_billable”,
“valuetype”:“text”,
“value”:“false”,
}
],
“join_conditions”: [
{
“source”:“project-tasks”,
“operation”:“equal”,
“valuetype”:“text”,
“value”:“active”,
“field”:“status”
}
]
}

Where the “project tasks” source is specified as a second source within the “join_conditions” expression. Here, the first trigger condition specified in the “conditions” expression is applied to the time_entries source and the second trigger condition specified by in the “join_conditions” expression is applied to the project_tasks database and the combined conditions are not met unless both the first and second trigger conditions occur.

As a second example of using the join_conditions key, consider the following notification specification.

Example 5

{
“source”:“time_entries”,
“intent”:“non-billable”,
“conditions”:
[
{
“operation”:“equal”,
“value”:“false”,
“field”:“is_billable”
}
],
“join_conditions”:
[
{
“source:project_manager”,
“operation”:“equal”,
“value”:“UserID-101”,
“field”:“user_id”,
}
]

where the trigger condition that the “is billable” value is “false” is applied to the time_entries source database and the trigger condition that the user ID value is “UserID-101” is applied to a project_manager database (not illustrated) and both trigger conditions need to occur to cause one or more related notifications to be generated.

In some cases it is advantageous if a trigger condition can be determined based on a subset of aggregated data in a database rather than on a single data value in the database. For instance, assume that a project manager wants to receive a notification any time any employee fails to bill at least 120 minutes during a work day. Referring again to FIG. 9, it can be seen that in the exemplary illustrated case, the user identified by UserID-77 spent several short periods (see 242) billing time to task-1 of project-A1 on Jun. 1, 1920 but that none of those durations alone exceeds the 120 minute trigger condition. Here, what the manager is really interested in is receiving a notification if the first employee's cumulative time entries during the day fall short of 120 minutes.

To aggregate data in a database like cumulative duration of minutes billed during a period, the disclosed system uses the “group_by” key. For instance, to aggregate data based on specific user identification numbers, the group_by key can be used in an expression as follows.
“group_by”:“UserID-#”
   Here, the system server automatically sums up total minutes of time entries for each system user so that there is a separate cumulative time value for each one of the employees.

To set a trigger condition for a grouped cumulative value (e.g., number of minutes billed during a workday), the disclosed system uses the “group_conditions” key. For instance, to set a notification trigger to indicate that a user logged less than 120 minutes during a day, the group_conditions key can be used in an expression as follows:

“group_coditions”:
[
{
“operation”:“less_than”,
“value”:“120”,
“value_type”:“number”,
“field”:“time_spent_minutes”
}
]

Referring again to FIG. 9, in the case of UserID-77, the cumulative time at 242 is 120 minutes so the less than 120 minute trigger condition would not be met. However, for UserID-34 the cumulative time at 244 is 80 minutes so the trigger condition in that case would be met.

An exemplary complete notification specification to report when an employee spent no time on an active project that uses each of a “join_conditions”, a “group_by” and a “group_conditions” expression is as follows:

Example 6

{
“source”: “time-entries”,
“audience_type”:“dynamic”,
“intent”:“non_billable”,
“audience”:“project_manager”,
“conditions”: [
{
“operation”: “equal”,
“field”: “is_billable”,
“value”: “false”
}
],
“join_conditions”: [
{
“source”: “project.status”,
“operation”: “equal”,
“field”: “status”,
“vaue”: “active”
}
],
“group_by”: [“user_id”],
“grouping_conditions”: [
“operation”: “equal”,
“value”: “0”,
“value_type”: “number”,
“field”: “time_spent_minutes”
}
]
}

The “data_filters” key (FIG. 12) enables additional filtering of data to meet additional trigger conditions for when notifications should be generated. For instance, to add a trigger limitation that notifications should only be sent to receivers when at least 80% of an initial project budget has been spent, the following expression may be used.

Example 7

{
“data_filters”:“:[
{
“operation”:“atleast”,
“value”:“80”
“value_type”:“percentage”,
“field”:“remaining_amount”,
“secondary_field”:“budget_amount”,
“goal”:“budget”
}
]
}

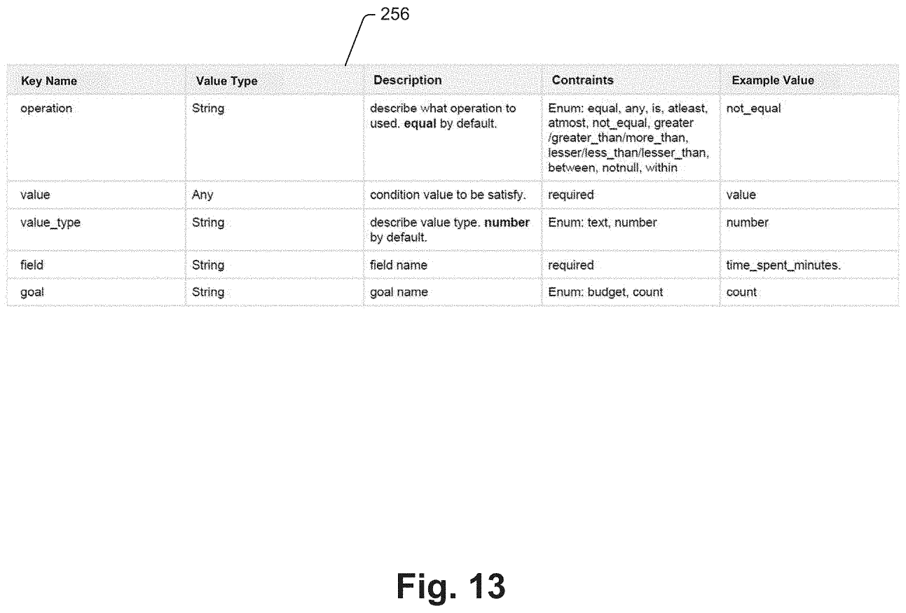

Data filter schema is illustrated in table format 256 in FIG. 13 where it can be seen that several JSON type keys are used to specify data filter trigger conditions including “operation”, “value”, “value_type” and “field” that are akin to the conditions keys described above. The data filter schema also include a “goal’ key which can be used to specify a value to be used in a notification template.

The “includes” key is similar to the join_conditions key in that it enables a programmer to specify a second or more additional target sources to be examined to identify additional trigger conditions where the “include_conditions” key is used to specify additional trigger conditions to apply to the additional source.

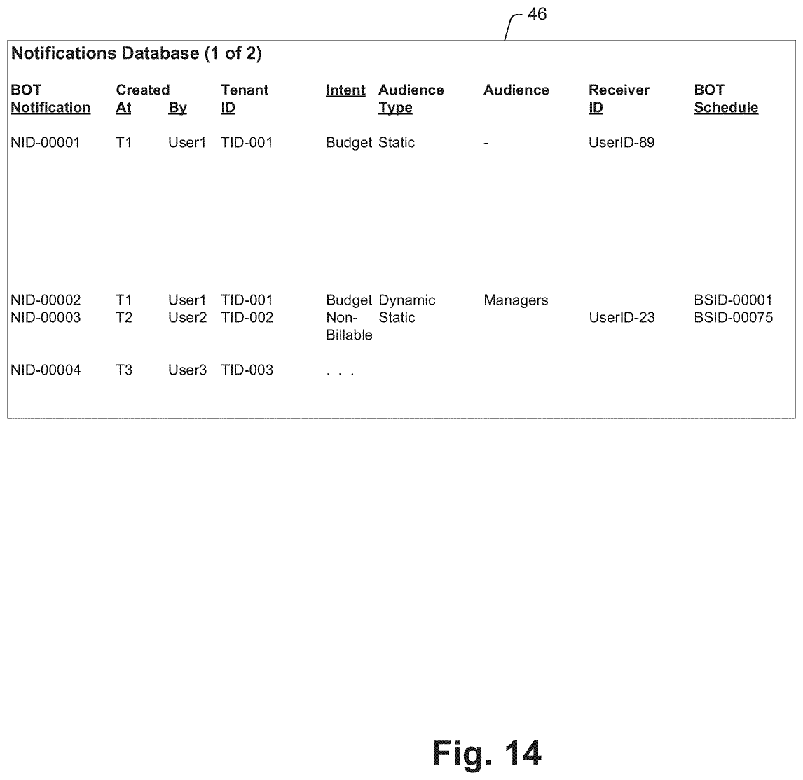

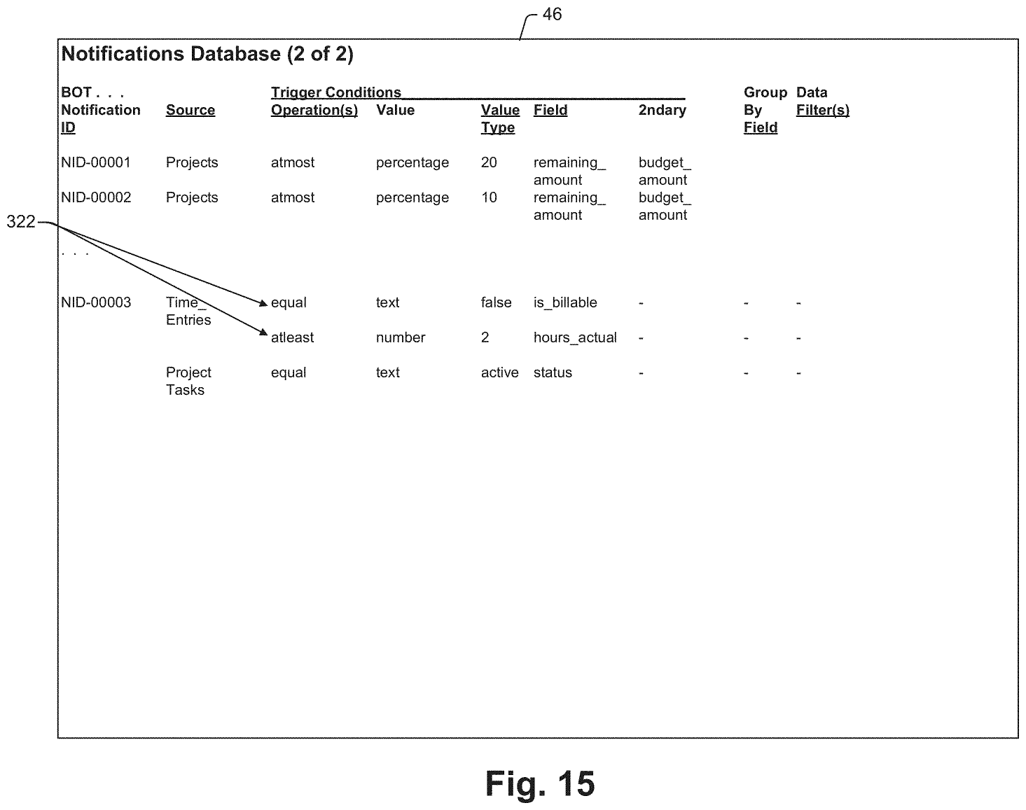

Referring again to FIG. 1, once the JSON or other text editor is used to define a notification specification, the notification specification is stored in a notifications database 46. An exemplary notification database 46 is illustrated in FIGS. 14 and 15. Database 46 is shown in a simplified table form in the interest of simplifying this explanation. Database 46 includes a BOT notification column that lists a separate identifier for each of the notification specifications defined for the system. As new notification specifications are generated, each is assigned a specific BOT notification ID. The database also includes columns indicating when notification specifications were created/implemented and by whom as well as a tenant ID column indicating an entity that is associated with each notification specification. For instance, a tenant may be an entity for which a programmer and several project managers work.

Referring still to FIGS. 14 and 15, the notifications database includes an intent column indicating an intent used to access a notification template (see again FIG. 3) as describe above. An “audience type” column indicates if the audience is static or dynamic and an “audience” column is used to indicate a class of recipient in the case of a dynamic audience type. For example, “project manager” is an audience classification so that, if the audience type is dynamic and the audience includes project managers, when a trigger condition occurs for an associated notification, the notification is sent to the project manager or managers associated with a project that meets the trigger conditions. A receiver ID column lists specific receivers for notifications when the audience type is static.

A BOT schedule column may point to a different database that indicates timing for when each notification trigger condition is to be checked and when notifications are to be sent once trigger conditions occur. In at least some cases it is contemplated that by default, trigger conditions will be detected at regular time intervals (e.g., every 15 minutes) starting at an initial default trigger time for a specific notification specification and notifications will be generated immediately any time a trigger condition occurs. Here, for instance, an initial trigger time for a notification specification reporting time entries for a workday may be 2 hours after normal working hours for the specific work day.

In at least some cases a programmer will be able to use the JSON or other text editor to specify a different initial trigger time for each specific notification specification. For instance, in the example above where the default is to transmit time entry notifications 2 hours after the end of normal working hours on a work day, a first project manager may instead want time entry notifications for projects managed by the first manager on Monday morning at 8 AM. Here, a programmer will be able to specify the preferred notification time via a JSON or other simple text editor. Similarly, in cases where there is no default time to report specific notifications the editor will be useable to set preferred times. For instance, assume the first project manager wants to receive a notification every Monday morning at 8 AM for each project the first manager manages where any weekend hours were billed to the project the prior weekend days. Here, a programmer can specify recurring Monday 8 AM times for checking the specified trigger conditions and generating and transmitting notifications to the first project manager.

Referring still to FIG. 15, the notifications database further includes a “source” column which indicates one or more target databases for each BOT notification ID to which trigger conditions are to be applied. Where there is only one source in the source column corresponding to a BOT notification ID, each of the trigger conditions specified in a conditions column is used to examine the single source database specified. In cases where there are two or more sources in the source column for one BOT notification ID, that indicates a “join_conditions” situation where at least two different trigger conditions are used to examine at least two different database sources. For instance, see NID-00003 in FIG. 15 where two sources 322 are listed in the source column and there is a separate trigger condition associated with each of the sources.

Referring again to FIG. 15, the trigger conditions column includes a set of sub-columns including an “operation(s)” column, a “value type” column, a “value” column, a “field” column and a “secondary field” column where each of those columns stores values as describes above and where the values and keys together define trigger conditions for the notification types. In some cases two or more trigger conditions apply to a single source (see again 322 in FIG. 15). There is at least one condition specified for each of the data sources in the source column. While not shown in FIGS. 14 and 15, “group_by”, “group_conditions”, “includes”, “includes_conditions” and “data_filters” keys and values may also be stored in database 46 where notification specifications include that type of information.

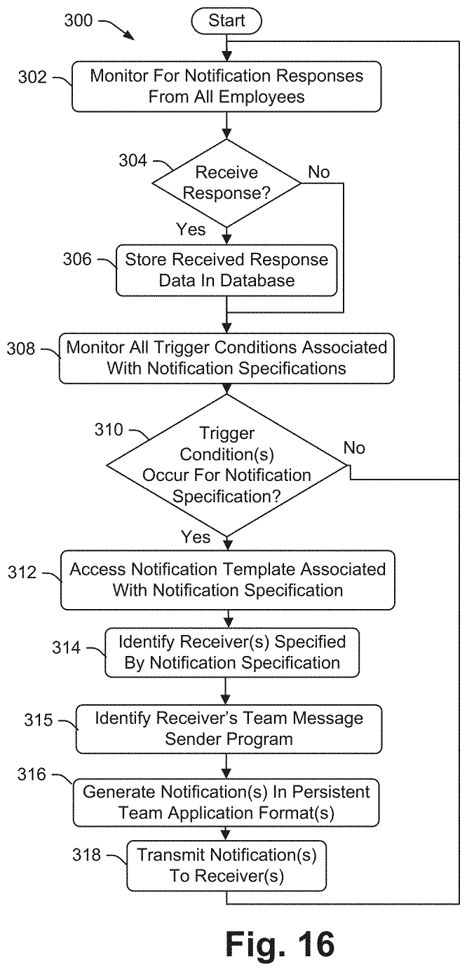

Branching notifications have been described above in some detail where, when a notification recipient receives a notification and generates a response to that notification, the response causes the system to generate a follow on notification to send to the receiver that responded or to a different receiver in some cases. FIG. 16 presents a flowchart 300 of a process that is consistent with the branching notification concept. Here, referring again to FIG. 1, it is assumed that a complete set of notification specifications is stored in database 46 and a complete set of intents and notification templates are stored in database 44 prior to commencement of process 300. It is also assumed that some notification templates generate simple report type notifications that provide reminders or warnings or alerts related to trigger conditions that occur within source databases while other templates query recipients for responses and may present easy to select response options or fields for receiving text responses as shown, for instance in FIGS. 5 through 7.

Referring again to FIG. 16, at process step 302, a system server 20 monitors all messages received in each of the team application programs that are used to send notifications to recipients for any responses to notifications received from any of the recipients. Thus, for instance, it may be that the server 20 has sent out 100 notifications to different receivers and is waiting for responses from each of those receivers at a specific point in time. At block 304, where no responses have been received, control passes down to block 308. At block 304 if a response is received back from one of the 100 notification receivers, control passes to block 306 where, in at least some cases, the response value is stored in a system response database (see 5460 in FIG. 1) or, in some cases, in projects database 200 or one of the other source databases. Where the response information is stored is less important than the fact that the response data is stored in a database that the system server has access to so the server can use that response data as trigger condition fodder that can be examined to identify additional notification triggers as explained hereafter. Thus, for the purposes of the present example it is assumed that the response database that stores receiver responses to queries may be targeted as yet another source via notification specification trigger conditions that cause follow on notifications to be generated.

Referring still to FIG. 16, at process block 308 server 20 monitors for all active notification specification trigger conditions in target database sources including the response database and/or other target source databases (e.g., the projects or invoices databases). Thus, here, for instance, assuming there are 5000 active notification specifications including 200 follow on type notification specifications (e.g., to generate follow on notifications in response to receiver responses) where each specification has a different trigger condition set, the server would monitor for all 5000 trigger condition sets in the database sources specified by the notification specifications where one of those databases may be the response database or the response data is stored in a different one of the target databases. In some cases a notification trigger condition set may include only one condition based on receiver response information. In other cases a notification trigger condition set may include specific response values as well as trigger events that occur in other source databases.

At decision block 310, where no additional trigger conditions occur, control passes back up to block 302 where the process described above continues. Once another trigger condition occurs at block 310, control passes down to block 312 where server 20 accesses a notification template specified by the notification specification associate with the trigger condition that occurred. At block 314 server 20 identifies one or more receivers that an instance of the notification is to be sent to and at block 315 server 20 identifies the team application or message sender programs (e.g., Slack, MSTeam, etc.) used by each identified receiver. At block 316 server 20 generates one or more instances of notifications using the notification templates where the notifications are in formats suitable for transmission using the team applications employed by each of the separate receivers. At block 318, server 20 transmits the notifications to the receivers and then control passes back up to block 302 where the process described above continues.

In at least some embodiments various key:values will be default values so that a programmer does not have to specify full sets of information for notification specifications in many cases. Thus, for instance, a dynamic audience and project managers may be default values, a default operation may always be “equal”, and a value type may always default to “text”. In this case, using a text editor a programmer could specify the Example 3 expression above in abbreviated form as follows.

Example 3 (abbreviated)

{
“source”:“time_entries”,
“intent”:“non-billable”,
“conditions”: [
{
“value”:“false”,
“field”:“is billable”
}
],

While a simple text editor type interface may be sufficient for some programmers to specify customized notifications in some cases, in other cases even that level of programming sophistication may be intimidating to project managers or other employees charged with the programming tasks. For this reason in at least some cases it is contemplated that a graphical user interface may be provided to intuitively guide a programmer through defining customized notification specifications. For instance, in a simple case, when a programmer accesses an exemplary GUI, the GUI may present a series of screen shots including questions seeking basic notification specification information and either selectable answer icons or one of more text entry fields for entering answers to the questions. For example, the GUI may elicit information indicating a target source, trigger conditions, notification audience, and some form of intent behind the notification.

In at least some cases when a programmer uses the GUI to define notification requirements, the system server may automatically generate and store a JSON type notification specification for driving the notification system described herein. In at least some cases it is contemplated that properly trained programmers will be able to switch back and forth between the GUI and the text editor to make specific notification specification changes in whatever editor interface that the programmer prefers and, most importantly, to allow full notification customization in cases where the GUI only offers a limited set of all system supported options.

The level of notification specification detail that can be specified via a GUI may be different in different notification defining systems. For instance, in a very simple case a GUI may simply present a subset of pre-canned notification types for selection where the programmer may only be able to select notification receivers. For example, systems are envisioned where there may be 200 different types of pre-canned notification definitions including, for instance, a first exemplary notification option to report to receivers when any project has 10% or less budget remaining, a second exemplary notification option to report to receivers when any project has 20% or less budget remaining, and so on and, once a notification option is selected, the programmer may simply select from a list of receivers and/or receiver classes (e.g., project managers, software engineers, etc.) to indicate who should receive the notifications.

In more complex cases the GUI may guide a programmer through a series of detailed queries in which the programmer specifies every possible detail related to customized notification specifications. In all cases queries and answers would be in the programmer's spoken language and should be extremely intuitive to answer.

In hybrid systems it is contemplated that a GUI may present some pre-canned notification options where the programmer will have the ability to adjust notification specification parameter to meet detailed preferences. For instance, a programmer may be able to select an exemplary notification option to report to project managers when any project managed by the manager has 10% or less budget remaining and then may be able to adjust the 10% value p or down to meet preferences or requirements, change the receiver from the project managers to one or more specific project managers and may be able to limit the projects reported to only projects started prior to Jun. 10, 2021.

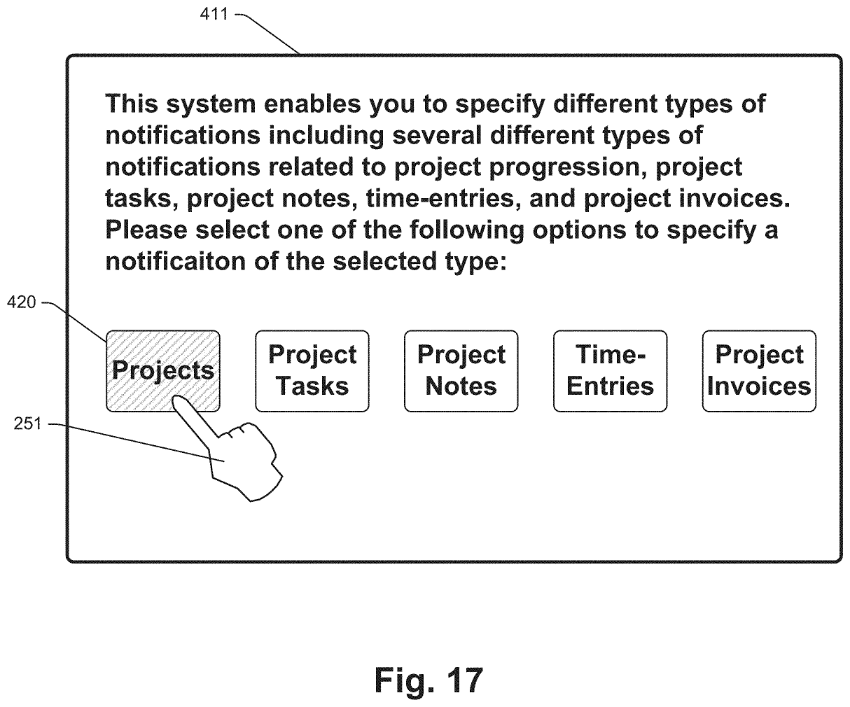

Referring now to FIGS. 17 through 23 a series of simplified screen shots are illustrated that show one GUI screenshot progression that is consistent with at least some aspects of the present disclosure. FIG. 17 show a first screen shot 411 that queries a programmer to select a general topic related to a notification specification that is to be defined from a list of general topics. In the illustrated example the general topic options are associated with target sources including project, project tasks, project note, time entries and project invoices that will include data that is examined to assess if trigger conditions that result in notifications occur. In other embodiments more descriptive general topics may be presented or topics that are not as tightly coupled to the target sources. In the screen shots that follow a hand icon 251 is shown which represents a programmer's finger interacting via touch with content on the screen in the case of a touch sensitive user interface display or a cursor controlled by a mouse or other device, or the like.

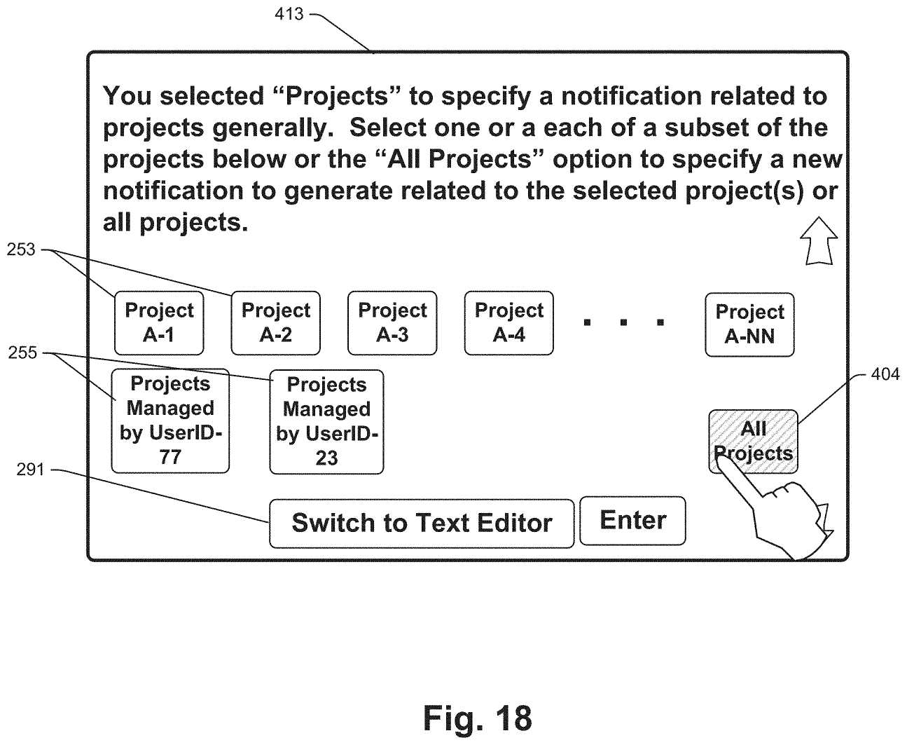

Depending on which general topic icon is selected, the server will next present a series of screen shots designed to define required notification specification information. In a case where a programmer selects “projects” icon 420 as illustrated, the server may next present the screen shot 413 in FIG. 18. In a different case where a programmer selects a different one of the icons in FIG. 17, the server would present a different second screen shot to gather information related to the other selection.

In the FIG. 18 screen shot 413 the server queries the programmer to select one, a subset, all, or a pre-defined subset of the projects for which notifications are to be specified and presents several selection options including separate project options 253, options for selecting all projects related to specific project managers 255 and an “All Projects” option 404. Other pre-defined project subsets are contemplated (e.g., all projects initiated after Jun. 1, 2020). Here, the programmer may select one or more of the individual project icons and then an “Enter” icon to specify one or a subset of the projects for which notifications are to be generated. Similarly, the programmer may select one or more of the manager associated icons 255 and then the Enter icon to select all projects related to one manager or a subset of managers. In a case where the programmer selects the “Project A-1” option, the server presents another screen shot to obtain additional specification defining information related to the project A-1 notification being defined. In the illustrated example, we assume a user selects the “All Projects” icon 404 as illustrated in FIG. 18 to specify that the notification specification being defined will apply to all projects.

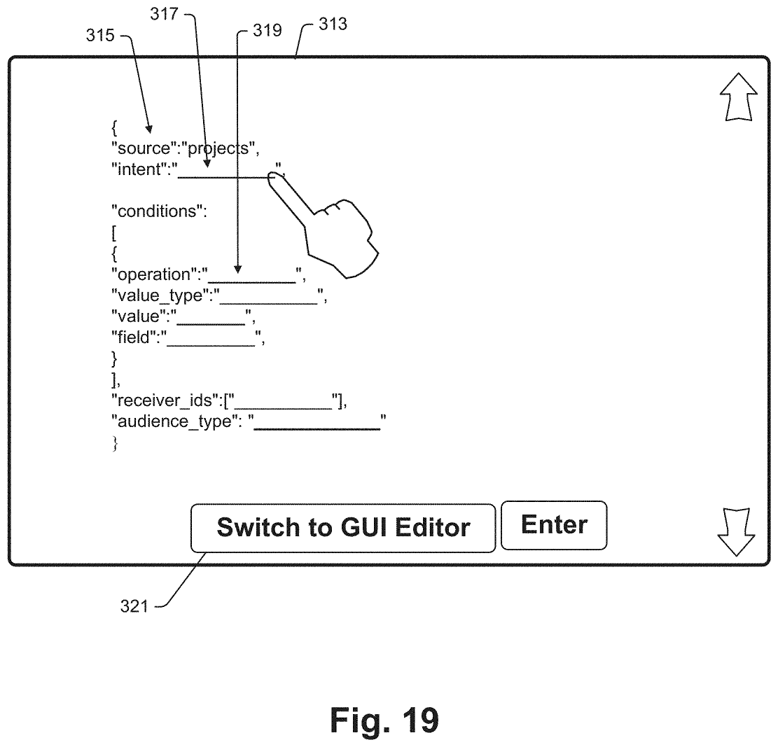

Referring again to FIG. 18, a “Switch to Text Editor” icon 291 may be presented in at least some systems which enables a programmer to switch between the GUI screen shots and a JSON or other simple text representation of the portion of a notification specification currently defined. For instance, in FIG. 18 if icon 291 is selected after the “projects” option in FIG. 17, a partially defined text editable JSON notification specification representation may be presented as shown in FIG. 19. In FIG. 19, a “projects” value 314 is associated with the source key 311 as the target source was defined in the present example when “projects” icon 420 was selected via the FIG. 17 screen shot. All other values associated with other specification keys are blank and include fields in which text may be entered to specify values as described above. As the programmer uses the GUI to specify additional notification specification parameters, the additional parameters are used to populate the value fields in the FIG. 19 JSON representation as well as to create additional key and value pairs when needed to capture the defined parameters. Where a programmer enters values in the blanks in FIG. 19, those values are stored as part of the notification specification. Screen shot 313 also includes a selectable “Switch to GUI Editor” icon 321 which can be used to switch back to the GUI screen shots. Where a programmer uses the text editor (FIG. 19) to specify key values and/or additional key:value pairs, those entries will be reflected in the GUI representation.

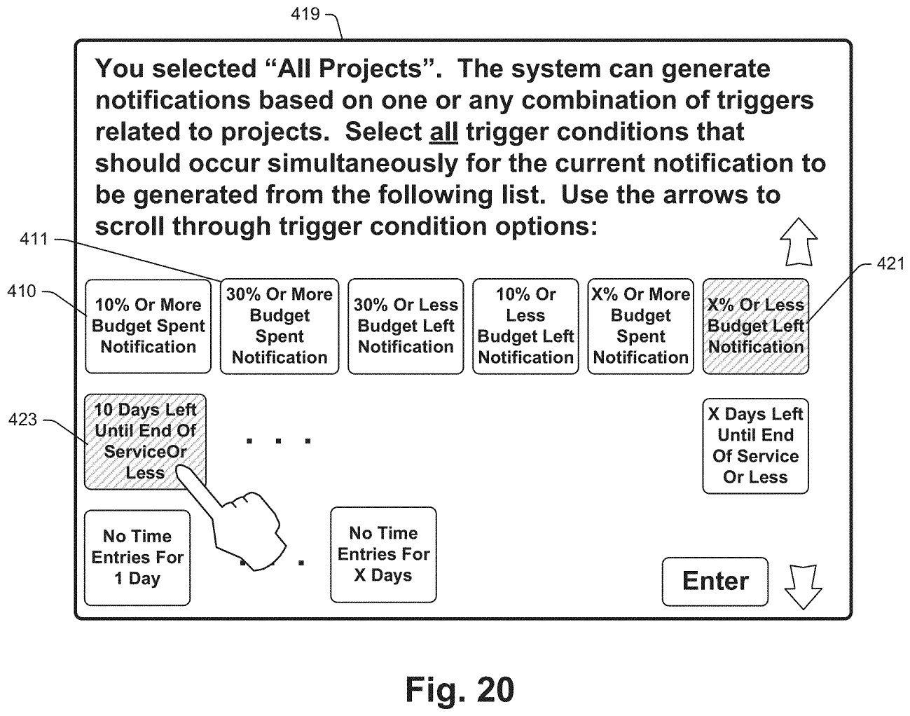

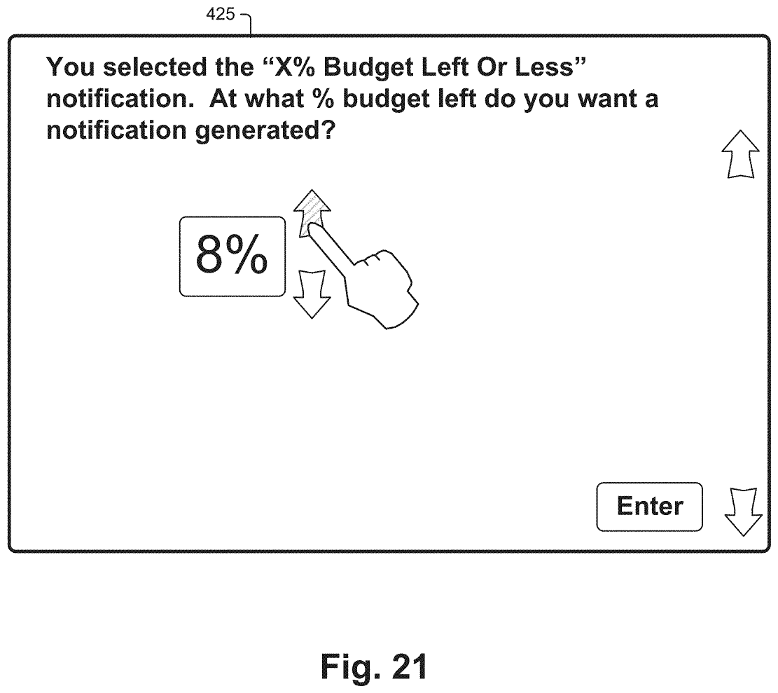

Referring again to FIG. 18, when the “All Projects” option is selected, the server presents the FIG. 20 screen shot 419 which presents instructions as well as a plurality of selectable icons where each icon is associated with a different one of a plurality of notification trigger conditions. For instance, first icon 410 is labelled “10% Or More Of Budget Spent Notification” indicating that at least one trigger condition will require that 10% or more of the budget has been spent. As another instance, selectable icon 412 is labelled “X % Or Less Budget Left Notification” which, when selected, allows a programmer to select a specific % budget left value. To this end, when icon 412 is selected, the system server may generate a next screen shot as in FIG. 21 where the server queries for entry of a budget percent remaining value by the programmer as illustrated. In the illustration the programmer uses up and down arrows to adjust the % value in an intuitive fashion.

Referring again to FIG. 20, the programmer is instructed to select one or a subset of trigger conditions from the presented set of condition icons. In FIG. 19 two icons are highlighted (e.g., left p to right cross hatched indicating selection) including the “X % or less budget left” icon 421 and a “10 days left until end of service” icon 423 meaning the programmer has selected each of those two conditions to firm a trigger condition set. Where trigger options are incompatible, when one selection is made, other incompatible selections may be removed from the screen shot or visually distinguished in some fashion so that the programmer recognizes that those options are no longer available. For instance, where a programmer selects the 30% or more budget spent trigger condition 411, the 10% or more option 410 is incompatible and the server may present icon 410 in a light grey style to indicate that that option is not available.

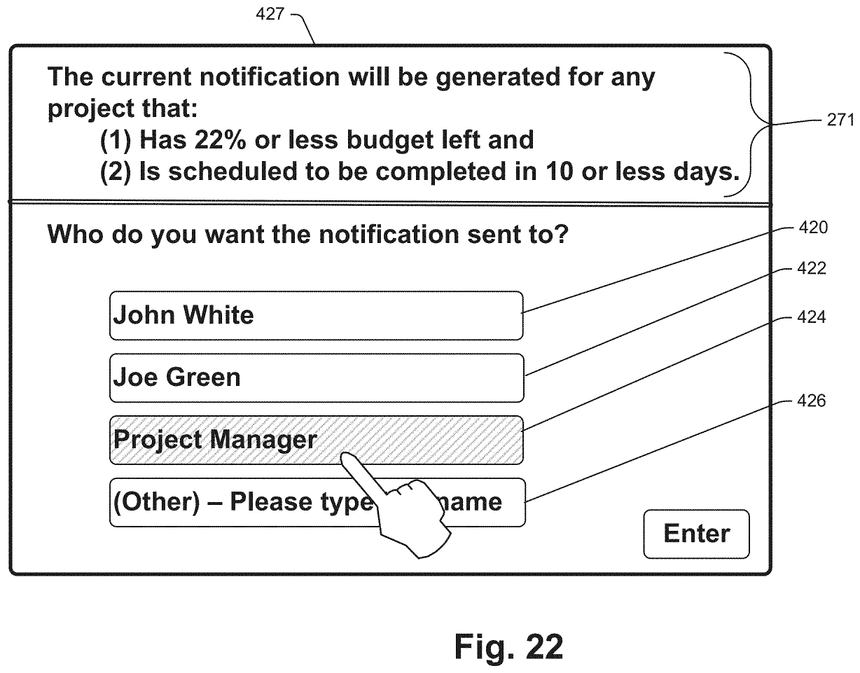

After a trigger condition set is selected the programmer selects the Enter icon in FIG. 20 to move on. Again, because icon 421 has been selected, the next screen shot may be the FIG. 21 screen that enables the programmer to select a specific % after which the FIG. 22 screen shot 427 may be presented.

Referring to FIG. 22, the next screen shot presents information related to the already specified notification specification information including a summary of selected trigger conditions at the top of the screen (see 271) and presents tools at the bottom of the screen for selecting a notification audience. Here, the query may present a list of possible receiver employees as at 420, 422, one or more selectable audience classes as at 424, and a field 426 for entering a receivers name to search a user database to identify specific users to be targeted for notifications. Again, the programmer can select one or a subset of the options presented and then select an Enter icon to submit the selections to the system server.

While not shown, it is contemplated that more screen shots may be presented to the programmer for defining other notification specification parameters including trigger dates, trigger times, and other parameters. In at least some cases the GUi arrangement shown in FIG. 22 where already defined parameters are presented in a summary form at the top of a screen or in some other persistent location (e.g., along a left side of the screen) with additional parameter specifying tools there below will be persistent so that the programmer always has context from the already defined parameters in which to make additional parameter decisions.

In at least some embodiments the server may be programmed to select a specific notification template to use to generate notifications based on other programmer selections made via the sequence of GUI screen shots. For instance, referring again to FIG. 19 where the programmer selects trigger conditions, the server may select a notification template based on selected trigger conditions as the trigger conditions are typically representative of project or other conditions that receivers will be interested in. Thus, for example, where icon 410 is selected in FIG. 19, the system server may automatically select the budget reporting template shown at 60 in FIG. 3 to use whenever the 10% budget level is reached in any tracked projects. Consistent with the JSON syntax and keys described above, to specify template 60, the server adds an expression “intent”:“budget”, to the text representation of the notification specification to define the intent and associated template 60 for the notification specification.

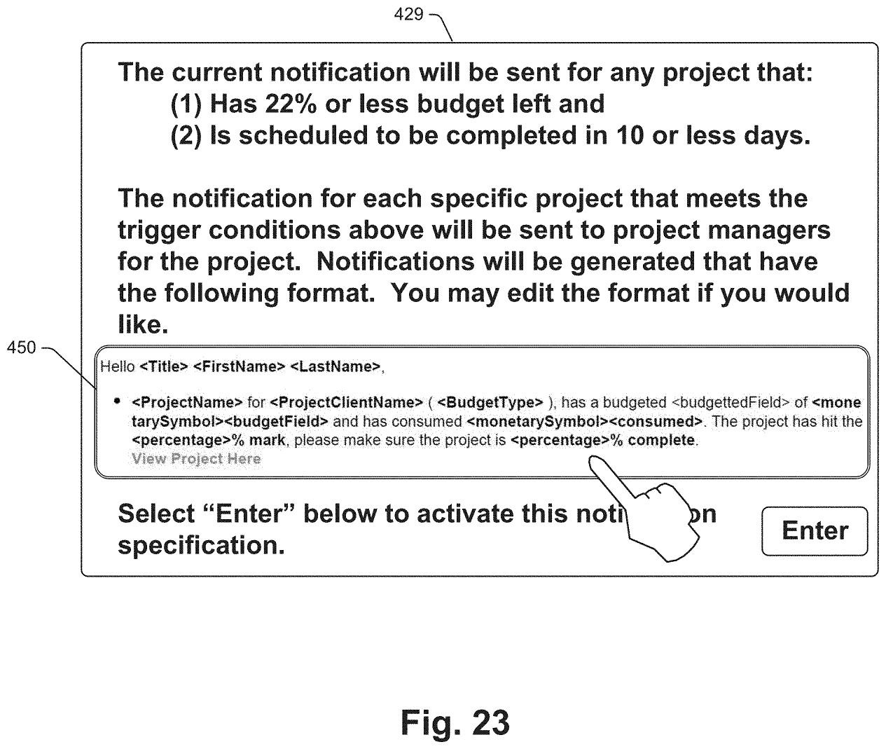

Next screen shot 429 in FIG. 23 summarizes the notification trigger conditions and audience information and also presents the template that the server will use to generate notifications at 450. Here, the programmer may be allowed to modify the template via simple text editing. Screen shot 429 enables the programmer to activate the notification specification via selection of an Enter icon.

The FIGS. 17-23 screen shots are simplified and in a typical system the sequence of screens and information presented thereby would be more complex.

In at least some cases it is contemplated that a programming GUI for defining a desired notification specification may include a text entry field where a programmer can enter an English or other common spoken language description of a type of notification that programmer wants the system to automatically generate and who that notification should be sent to. For instance, a programmer may type the following in the field, “Report all projects to all managers that have 10% or less budget remaining”. In this case, the system server 20 may be programmed to assess the meaning of the entered text and then instantiate an instance of a notification specification that is consistent with the programmer's request. In this case the server would generate JSON expressions to represent the programmers entered text and may be programmed to recognize other notification specification required information and to generate a query seeking that information. For instance the exemplary text entered above does not specify an audience so in that case the server may generate a query requesting audience information for the notification. In other cases instead of requiring a programmer to enter notification specifying information via text entry or the like, the system may support audio input where a user can verbally describe the notification she wants to implement and a system server can caption the programmer's utterances to generate a text description and then process that text description as described above.

While the invention may be susceptible to various modifications and alternative forms, specific embodiments have been shown by way of example in the drawings and have been described in detail herein. However, it should be understood that the invention is not intended to be limited to the particular forms disclosed. Thus, the invention is to cover all modifications, equivalents, and alternatives falling within the spirit and scope of the invention as defined by the following appended claims.

To apprise the public of the scope of this invention, the following claims are made:

What is claimed is:

1. A system for managing professional services for an entity that employs a plurality of persons wherein each person is a resource, the system comprising:
a plurality of target source databases, each source database storing a plurality of service records one service record for each of a plurality of professional service activities;
a plurality of team messaging application programs, each messaging application program used by at least a subset of the resources to electronically communicate;
a processor programmed to perform the steps of:
during a notification specification programming process:
(i) receiving a target source indication from a programmer wherein the target source identifies one of the plurality of target source databases;
(ii) receiving a trigger condition set from a programmer wherein the set of trigger conditions specify at least a first database condition that warrants a notification; and
(iii) receiving audience identifying information indicating at least a first receiver to receive notifications upon the trigger condition set occurring;
during normal operation after programming:
(i) examining each service record for occurrence of the trigger condition set;
(ii) for each service record where trigger condition set occurs:
(a) using a notification template to instantiate a notification instance;
(b) identifying the messaging application program used by the at least a first receiver; and
(c) transmitting the notification instance to the at least a first receiver via the identified messaging application program.

2. The system of claim 1 wherein the steps of receiving a target source indication and a trigger condition set include presenting a simple text editor via a display screen and receiving text expressions from a programmer that are entered into the text editor via a user input device.

3. The system of claim 2 wherein the simple text editor is a JSON text editor.

4. The system of claim 1 wherein the step of receiving audience identifying information includes receiving default audience specifying information.

5. The system of claim 4 wherein the default audience specifying information includes receiving information that specifies a manager of professional service activities associated with a professional service record.

6. The system of claim 1 further including a notification template database that stores a plurality of notification templates and wherein the processor is further programmed to perform the steps of receiving a notification template selection from a programmer that identifies at least one of the plurality of notification templates to use to generate instances of notifications when trigger conditions occur.

7. The system of claim 1 wherein at least a subset of the trigger conditions in the trigger condition set each includes an operation, a value and at least one field.

8. The system of claim 1 wherein the notification instance includes a query and a plurality of receiver selectable answers and wherein, when an answer is selected by the first receiver, the processor is further programmed to receive the answer in a return message via the identified messaging application program.

9. The system of claim 8 further including a notification specification database that stores a plurality of notification specifications including at least a second notification specification that includes a second trigger condition set, wherein information in the return message operates as a trigger condition in the second trigger condition set so that the system processor responds to the return message by generating and transmitting a second notification to the receiver.

10. The system of claim 1 wherein the audience is dynamic.

11. The system of claim 10 wherein the audience is static and includes specific persons.

12. The system of claim 1 wherein the notification template includes text and variable fields and wherein the processor fills in the variable fields automatically using information from other system databases.

13. The system of claim 1 wherein the plurality of target source databases include at least one project management database.

14. The system of claim 1 wherein the plurality of target source databases includes at least one invoicing database.

15. The system of claim 1 wherein the step if receiving a target source includes receiving at least first and second target sources, the step of receiving a trigger condition set includes receiving first and second trigger condition sets associate with the first and second target sources, respectively, and the step of examining each service record for occurrence of the trigger condition set including examining each service record in the first target source for the first condition set and each service record in the second target source for the second trigger condition set

16. The system of claim 1 wherein the receiving steps include providing a graphical user interface via a display screen that presents a series of screen shots that request information related to target source, trigger condition set and audience, the processor further programmed to convert programmer source, trigger condition set and audience definitions into simple text expressions that together define a text based notification specification.

17. The system of claim 1 wherein each service record includes information related to resources allocated to the associated professional service activity.

18. The system of claim 1 wherein the messaging programs include Slack message sender and MSTeam Message Sender.

19. A system for managing professional services for an entity that employs a plurality of persons wherein each person is a resource and each resource regularly uses one of several different team messaging application programs to communicate with other resources, the system comprising:
a system processor;
at least a first source database storing a plurality of service records, one service record for each of a plurality of professional service activities;
a plurality of team messaging application programs, each messaging application program used by at least a subset of the resources to electronically communicate;
a notification specification database storing a plurality of notification specifications, each notification specification defining a trigger condition set including at least one trigger condition, a notification template, and audience specifying information, at least a subset of the notification templates including a query and receiver selectable options which, when selected, generate a response that is transmitted to the system processor, the system processor programmed to perform the steps of:
(i) receiving and storing responses from resources to prior transmitted notifications in a response database;
(ii) examining at least a subset of the service records and the response database for any one of the trigger condition sets;
(iii) upon one of the trigger condition sets occurring, accessing the notification template associated with the trigger condition set that occurred;
(iv) using the audience specifying information associated with the trigger condition set to identify at least a first receiver;
(v) identify the team messaging application program used by the at least a first receiver;
(vi) generating a notification using the accessed notification template; and
(vii) transmitting the notification to the at least a first receiver using the identified team application program.

20. A system for managing professional services for an entity that employs a plurality of persons wherein each person is a resource, the system comprising:
a system processor;
at least a first source database storing a plurality of service records, one service record for each of a plurality of professional service activities;
a plurality of team messaging application programs, each resource routinely using one of the messaging application programs to electronically communicate;
a notification specification database storing a plurality of notification specifications, each notification specification defining a trigger condition set including at least one trigger condition, the system processor programmed to perform the steps of:
(i) examining at least a subset of the service records for any one of the trigger condition sets;
(iii) upon one of the trigger condition sets occurring, accessing the notification template associated with the trigger condition set that occurred;
(iv) identify the team messaging application program used by at least a first receiver that is to receive a notification;
(vi) generating a notification using the accessed notification template; and
(vii) transmitting the notification to the at least a first receiver using the identified team application program.
